(19) United States
(12) Patent Application Publication
(10) Pub. No.: US 2021/0189080 A1
(43) Pub. Date: Jun. 24, 2021

(54) COMPOSITION FOR FORMING HARD COAT, METHOD FOR PRODUCING ARTICLE HAVING HARD COAT, HARD COAT, HARD-COATED ARTICLE, AND SILANE-MODIFIED ALICYCLIC COMPOUND

(71) Applicant: TOKYO OHKA KOGYO CO., LTD., Kawasaki-shi (JP)

(72) Inventors: Jiro HIKIDA, Kawasaki-shi (JP); Masato MIYAZAKI, Kawasaki-shi (JP); Dai SHIOTA, Kawasaki-shi (JP)

(21) Appl. No.: 17/119,138

(22) Filed: Dec. 11, 2020

(30) Foreign Application Priority Data
Dec. 12, 2019 (JP) 2019-224923

(51) Int. Cl. C08J 7/046; C08F 267/04; C08F 222/04; C08K 5/544

(52) U.S. Cl. CPC C08J 7/046; C08F 267/04; C08F 2800/10; C08K 5/544; C08F 222/04

(57) ABSTRACT

A composition that makes it easy to form a hard coat having both high hardness and high transparency regardless of the surface hardness level of the article to be hard-coated; a method for producing an article having a hard coat using such a composition; a hard coat including a cured product of such a composition; a hard-coated article having such a hard coat; and a silane-modified alicyclic compound suitable for use as a component of such a composition. The composition includes a silane-modified alicyclic compound that is a mixture of products of reaction of an alicyclic tetracarboxylic dianhydride with an aminosilane compound having a specific structure with a hydrolyzable silyl group.

### BACKGROUND OF THE INVENTION

### Field of the Invention

The present invention relates to a composition for forming a hard coat, a method for producing an article having a hard coat using the composition, a hard coat produced using the composition, a hard-coated article having the hard coat, and a silane-modified alicyclic compound suitable for use as a component of the composition.

### Related Art

In the conventional art, the surface of various displays and the surface of various articles, such as automotive interior parts, are provided with a hard coat for such purposes as anti-scratching. Such a hard coat is often formed through applying a curable composition to a surface of an article.

A known composition for forming a hard coat is, for example, a thermosetting resin composition including a copolymer (C) obtained by reaction between a macromonomer (A) and a polymerizable double bond-containing compound (B) or between a macromonomer (A), a polymerizable double bond-containing compound (B), and a tri- or poly-functional (meth)acrylate (a), in which the macromonomer (A) is a product obtained through reaction of a raw material containing a tri- or poly-functional (meth)acrylate (a) (see Patent Document 1).

Patent Document 1: Japanese Unexamined Patent Application, Publication No. 2015-157935

### SUMMARY OF THE INVENTION

Unfortunately, the hard coat made from the composition known in the conventional art has room for improvement in achievement of both high hardness and high transparency. Moreover, when the composition known in the conventional art is used to form a hard coat on a soft surface, the resulting hard-coated article can often have insufficient surface hardness.

The present invention has been made in light of the above problem, and an object of the present invention is to provide a composition that makes it easy to form a hard coat having both high hardness and high transparency regardless of the surface hardness level of the article to be hard-coated, to provide a method for producing an article having a hard coat using such a composition, to provide a hard coat including a cured product of such a composition, to provide a hard-coated article having such a hard coat, and to provide a silane-modified alicyclic compound suitable for use as a component of such a composition.

The present inventors have completed the present invention based on the findings that the above problem can be solved using a hard coat-forming composition containing a silane-modified alicyclic compound that is a mixture of products of reaction of an alicyclic tetracarboxylic dianhydride with an aminosilane compound having a specific structure containing a hydrolyzable silyl group. Specifically, the present invention provides the following aspects.

A first aspect of the present invention is directed to a composition for forming a hard coat, the composition including a silane-modified alicyclic compound having a hydrolyzable silyl group,
the silane-modified alicyclic compound being a mixture of products of reaction of 1 part by mole of an alicyclic tetracarboxylic dianhydride with more than 0.5 parts by mole of an aminosilane compound represented by formula (a-1) below.

R^{a1}ₜR^{a2}₍₃₋ₜ₎Si—R^{a3}—NH₂ (a-1)

In formula (a-1), R^{a1} is a group capable of undergoing hydrolysis to produce a silanol group, R^{a2} is an optionally substituted hydrocarbon group, R^{a3} is an aliphatic chain group, and t is 2 or 3.

A second aspect of the present invention is directed to a composition for forming a hard coat,
the composition including a compound represented by formula (a-I) below only as a silane-modified alicyclic compound or including, as a silane-modified alicyclic compound,
a combination of a compound represented by formula (a-I) below and a compound represented by formula (a-II-1) below and/or a compound represented by formula (a-II-2) below.

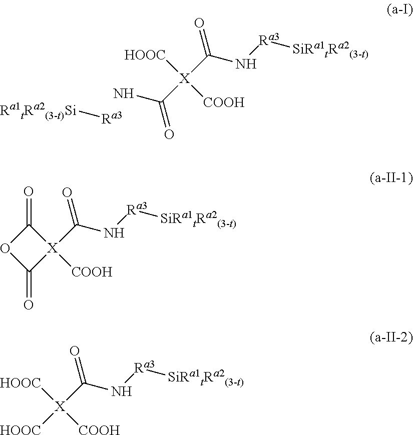

In formulas (a-I), (a-II-1), and (a-II-2), R^{a1} is a group capable of undergoing hydrolysis to produce a silanol group, R^{a2} is an optionally substituted hydrocarbon group, R^{a3} is an aliphatic chain group, t is 2 or 3, and X is a tetravalent aliphatic group containing an alicyclic skeleton.

A third aspect of the present invention is directed to a method for producing an article having a hard coat, the method including: applying the composition according to the first or second aspect to a surface of a coating target to form a coating film; and
drying the coating film.

A fourth aspect of the present invention is directed to a hard coat including a cured product of the composition according to the first or second aspect.

A fifth aspect of the present invention is directed to a hard-coated article including an article and the hard coat according to the fourth aspect provided on a surface of the article.

A sixth aspect of the present invention is directed to a silane-modified alicyclic compound represented by formula (a-I), (a-II-1), or (a-II-2) below.

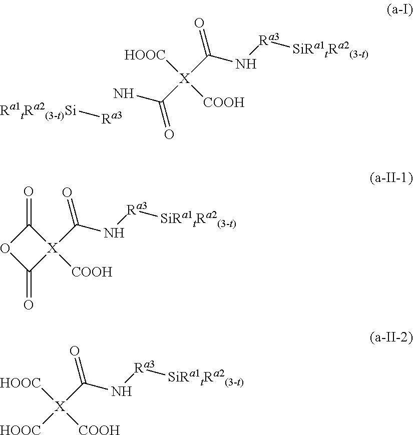

In formulas (a-I), (a-II-1), and (a-II-2), R^{a1} is a group capable of undergoing hydrolysis to produce a silanol group, R^{a2} is an optionally substituted hydrocarbon group, R^{a3} is an aliphatic chain group, t is 2 or 3, and X is a tetravalent aliphatic group containing an alicyclic skeleton.

The present invention makes it possible to provide a composition that makes it easy to form a hard coat having both high hardness and high transparency regardless of the surface hardness level of the article to be hard-coated, to provide a method for producing an article having a hard coat using such a composition, to provide a hard coat including a cured product of such a composition, to provide a hard-coated article having such a hard coat, and to provide a silane-modified alicyclic compound suitable for use as a component of such a composition.

### DETAILED DESCRIPTION OF THE INVENTION

### «Composition for Forming Hard Coat»

The composition for forming a hard coat contains a silane-modified alicyclic compound having a hydrolyzable silyl group. The silane-modified alicyclic compound is a mixture of products of reaction of 1 part by mole of an alicyclic tetracarboxylic dianhydride with more than 0.5 parts by mole of an aminosilane compound represented by formula (a-1) below.

R^{a1}ₜR^{a2}₍₃₋ₜ₎Si—R^{a3}—NH₂ (a-1)

In formula (a-1), R^{a1} is a group capable of undergoing hydrolysis to produce a silanol group, R^{a2} is an optionally substituted hydrocarbon group, R^{a3} is an aliphatic chain group, and t is 2 or 3.

The use of the composition including the silane-modified alicyclic compound makes it easy to form a hard coat having both high hardness and high transparency regardless of the surface hardness level of the article to be hard-coated.

### <Silane-Modified Alicyclic Compound>

As mentioned above, the silane-modified alicyclic compound is a mixture of products of reaction of 1 part by mole of an alicyclic tetracarboxylic dianhydride with more than 0.5 parts by mole of an aminosilane compound represented by formula (a-1).

For the hardness of the hard coat formed using the composition, the amount of the aminosilane compound to be reacted with 1 part by mole of the alicyclic tetracarboxylic dianhydride is preferably 0.7 parts by mole or more and 2.5 parts by mole or less, more preferably 1.0 part by mole or more and 2.3 parts by mole or less, and even more preferably 1.5 parts by mole or more and 2.2 parts by mole or less.

The alicyclic tetracarboxylic dianhydride may be reacted with the aminosilane compound under any conditions where excessive hydrolysis of the aminosilane compound does not occur and the desired reaction proceeds successfully. The reaction of the alicyclic tetracarboxylic dianhydride with the aminosilane compound is preferably carried out in an organic solvent. The organic solvent is preferably, for example, free of any functional group capable of reacting with the alicyclic tetracarboxylic dianhydride or the aminosilane compound, such as a hydroxyl group or an amino group.

Examples of the organic solvent for use in the reaction of the alicyclic tetracarboxylic dianhydride with the aminosilane compound include nitrogen-containing polar solvents such as N-methyl-2-pyrrolidone, N,N-dimethylacetamide, N,N-diethylacetamide, N,N-dimethylformamide, N,N-diethylformamide, N-methylcaprolactam, and N,N,N′,N′-tetramethylurea; polar lactone solvents such as β-propiolactone, γ-butyrolactone, γ-valerolactone, δ-valerolactone, γ-caprolactone, and ε-caprolactone; dimethyl sulfoxide; acetonitrile; fatty acid esters such as ethyl lactate and butyl lactate; ethers such as diethylene glycol dimethyl ether, diethylene glycol diethyl ether, dioxane, tetrahydrofuran, methyl cellosolve acetate, and ethyl cellosolve acetate; and phenolic solvents such as cresols and xylene-based mixed solvents. One of these organic solvents may be used alone, or two or more of these organic solvents may be used in combination. While the organic solvent may be used in any amount, the total mass of the alicyclic tetracarboxylic dianhydride and the aminosilane compound is preferably 5% by mass or more and 50% by mass or less based on the mass of the reactant solution.

Among these organic solvents, nitrogen-containing polar solvents such as N-methyl-2-pyrrolidone, N,N-dimethylacetamide, N,N-diethylacetamide, N,N-dimethylformamide, N,N-diethylformamide, N-methylcaprolactam, and N,N,N′,N′-tetramethylurea are preferred because they easily allow the reaction to proceed successfully and have the ability to dissolve the silane-modified alicyclic compound.

The alicyclic tetracarboxylic dianhydride and the aminosilane compound may be reacted at any temperature at which the desired reaction can proceed successfully. Typically, the reaction temperature is preferably −10° C. or more and 120° C. or less, and more preferably 5° C. or more and 30° C. or less. In general, the reaction time is preferably 0.5 hours or more and 24 hours or less, and more preferably 1 hour or more and 5 hours or less, although it varies depending on the composition of raw materials used.

A single alicyclic tetracarboxylic dianhydride and a single aminosilane compound may be used, or two or more alicyclic tetracarboxylic dianhydrides and two or more aminosilane compounds may be used in combination.

### [Alicyclic Tetracarboxylic Dianhydride]

The alicyclic tetracarboxylic dianhydride may be any carboxylic dianhydride derived from an alicyclic group-containing tetracarboxylic acid compound. As long as the alicyclic tetracarboxylic dianhydride contains an alicyclic group, the acid anhydride group does not always have to be bonded to the alicyclic group in the alicyclic tetracarboxylic dianhydride. In the alicyclic tetracarboxylic dianhydride, the acid anhydride group is preferably bonded to the alicyclic group in view of the hardness and mechanical properties of the hard coat formed using the composition.
It should be noted that the alicyclic tetracarboxylic dianhydride contains no aromatic group.

The alicyclic tetracarboxylic dianhydride may contain a hetero atom in a moiety other than the acid anhydride group. The hetero atom may be, for example, O, N, S, P, Se, or halogen.

The alicyclic tetracarboxylic dianhydride is preferably, for example, an alicyclic compound having two carboxylic anhydride groups bonded thereto. Examples of such an alicyclic compound include a cycloalkane having 4 or more and 20 or less carbon atoms, or a polycycloalkane; an alicyclic compound having a cycloalkane moiety with 4 or more and 20 or less carbon atoms or having a polycycloalkane moiety, in which the moiety has —CH═CH— substituted for some of —CH₂—CH₂— bonds; and a compound having a cycloalkane moiety with 4 or more and 20 or less carbon atoms or having a polycycloalkane moiety, in which the moiety has O or S substituted for some of methylene groups.

Preferred examples of the alicyclic tetracarboxylic dianhydrides include 1,2,3,4-cyclobutanetetracarboxylic dianhydride, 1,2,3,4-cyclopentanetetracarboxylic dianhydride, 1,2,3,4-cyclohexanetetracarboxylic dianhydride, 1,2,4,5-cyclohexanetetracarboxylic dianhydride, dicyclohexyl-3,4,3′,4′-tetracarboxylic dianhydride, 1,2,3,4-tetramethyl-1,2,3,4-cyclobutanetetracarboxylic dianhydride, tricyclo[6.4.0.0^{2,7}]dodecane-1,8:2,7-tetracarboxylic dianhydride, and bicyclo[2.2.2]oct-7-ene-2,3,5,6-tetracarboxylic dianhydride.

Besides the above alicyclic tetracarboxylic dianhydrides, a compound represented by formula (a-2-1) below is preferred as the alicyclic tetracarboxylic dianhydride.

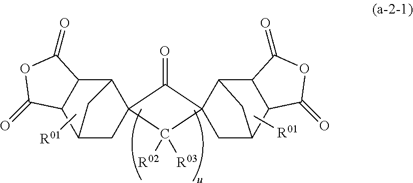

In formula (a-2-1), R⁰¹, R⁰², and R⁰³ each independently represent one selected from the group consisting of a hydrogen atom, an alkyl group having 1 or more and 10 or less carbon atoms, and a fluorine atom, and u represents an integer of 0 or more and 12 or less.

In formula (a-2-1), the alkyl group which may be selected for R⁰¹ is an alkyl group having 1 or more and 10 or less carbon atoms. If the alkyl group has more than 10 carbon atoms, the resulting polyimide resin may tend to have low heat resistance. The alkyl group for R⁰¹ preferably has 1 or more and 6 or less carbon atoms, more preferably 1 or more and 5 or less carbon atoms, even more preferably 1 or more and 4 or less carbon atoms, further more preferably 1 or more and 3 or less carbon atoms, so that it will be easy to obtain a hard coat with excellent heat resistance. The alkyl group for R⁰¹ may be linear or branched.

In formula (a-2-1), each R⁰¹ is more preferably independently a hydrogen atom or an alkyl group having 1 or more and 10 or less carbon atoms, so that it will be easy to form a hard coat with excellent heat resistance. In formula (a-2-1), each R⁰¹ is more preferably a hydrogen atom, a methyl group, an ethyl group, an n-propyl group, or an isopropyl group, and even more preferably a hydrogen atom or a methyl group, so that the tetracarboxylic dianhydride is easy to obtain or purify. In formula (a-2-1), the plurality of R⁰¹ is preferably the same group so that the tetracarboxylic dianhydride represented by formula (a-2-1) will be easy to purify.

In formula (a-2-1), u represents an integer of 0 or more and 12 or less. If u is more than 12, the tetracarboxylic dianhydride represented by formula (a-2-1) may be difficult to purify. The upper limit of u is preferably 5, and more preferably 3, so that the tetracarboxylic dianhydride represented by formula (a-2-1) will be easy to purify. The lower limit of u is preferably 1, and more preferably 2, so that the tetracarboxylic dianhydride represented by formula (a-2-1) will be chemically stable. In formula (a-2-1), u is even more preferably 2 or 3.

In formula (a-2-1), the alkyl group having 1 or more and 10 or less carbon atoms which may be selected for R⁰² and R⁰³ is similar to the alkyl group having 1 or more and 10 or less carbon atoms which may be selected for R⁰¹. In order for the tetracarboxylic dianhydride represented by formula (a-2-1) to be easy to purify, R⁰² and R⁰³ are preferably a hydrogen atom or an alkyl group having 1 or more and 10 or less carbon atoms (more preferably 1 or more and 6 or less, even more preferably 1 or more and 5 or less, further more preferably 1 or more and 4 or less, still more preferably 1 or more and 3 or less carbon atoms), and yet more preferably a hydrogen atom or a methyl group.

Examples of the tetracarboxylic dianhydride represented by formula (a-2-1) include norbornane-2-spiro-α-cyclopentanone-α′-spiro-2″-norbornane-5,5″,6,6″-tetracarboxylic dianhydride (also known as norbornane-2-spiro-2′-cyclopentanone-5′-spiro-2″-norbornane-5,5″,6,6″-tetracarboxylic dianhydride), methylnorbornane-2-spiro-α-cyclopentanone-α′-spiro-2″-(methylnorbornane)-5,5″,6,6″-tetracarboxylic dianhydride, norbornane-2-spiro-α-cyclohexanone-α′-spiro-2″-norbornane-5,5″,6,6″-tetracarboxylic dianhydride (also known as norbornane-2-spiro-2′-cyclohexanone-6′-spiro-2″-norbornane-5,5″,6,6″-tetracarboxylic dianhydride), methylnorbornane-2-spiro-α-cyclohexanone-α′-spiro-2″-(methylnorbornane)-5,5″,6,6″-tetracarboxylic dianhydride, norbornane-2-spiro-α-cyclopropanone-α′-spiro-2″-norbornane-5,5″,6,6″-tetracarboxylic dianhydride, norbornane-2-spiro-α-cyclobutanone-α′-spiro-2″-norbornane-5,5″,6,6″-tetracarboxylic dianhydride, norbornane-2-spino-α-cycloheptanone-α′-spino-2″-norbornane-5,5″,6,6″-tetracarboxylic dianhydride, norbornane-2-spiro-α-cyclooctanone-α′-spino-2″-norbornane-5,5″,6,6″-tetracarboxylic dianhydride, norbornane-2-spino-α-cyclononanone-α′-spino-2″-norbornane-5,5″,6,6″-tetracarboxylic dianhydride, norbornane-2-spiro-α-cyclodecanone-α′-spiro-2″-norbornane-5,5″,6,6″-tetracarboxylic dianhydride, norbornane-2-spiro-α-cycloundecanone-α′-spiro-2″-norbornane-5,5″,6,6″-tetracarboxylic dianhydride, norbornane-2-spiro-α-cyclododecanone-α′-spiro-2″-norbornane-5,5″,6,6″-tetracarboxylic dianhydride, norbornane-2-spino-α-cyclotridecanone-α′-spino-2″-norbornane-5,5″, 6,6″-tetracarboxylic dianhydride, norbornane-2-spiro-α-cyclotetradecanone-α′-spino-2″-norbornane-5,5″,6,6″-tetracarboxylic dianhydride, norbornane-2-spiro-α-cyclopentadecanone-α′-spiro-2″-norbornane-5,5″,6,6″-tetracarboxylic dianhydride, norbornane-2-spiro-α-(methylcyclopentanone)-α′-spiro-2″-norbornane-5,5″,6,6″-tetracarboxylic dianhydride, and norbornane-2-spiro-α-(methylcyclohexanone)-α′-spiro-2″-norbornane-5,5″,6,6″-tetracarboxylic dianhydride.

For adjustment of the thermal physical properties, mechanical properties, optical properties, and other properties of the hard coat, the tetracarboxylic dianhydride represented by formula (a-2-1) preferably includes at least one of a compound represented by formula (a-2-1a):

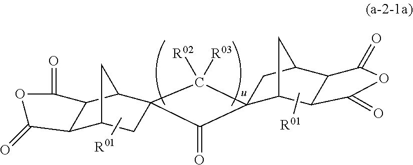

wherein R⁰¹, R⁰², R⁰³, and u are the same as defined for formula (a-2-1), and
a compound represented by formula (a-2-1b):

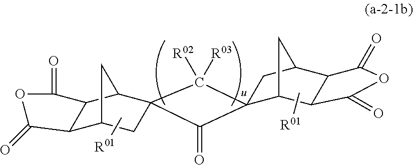

wherein R⁰¹, R⁰², R⁰³, and u are the same as defined for formula (a-2-1), and
the total content of the compounds represented by formulas (a-2-1a) and (a-2-1b) is preferably 30% by mole or more based on the total moles of the tetracarboxylic dianhydrides.

The compound represented by formula (a-2-1a) is an isomer (trans-endo-endo) of the tetracarboxylic dianhydride represented by formula (a-2-1) in which the two norbornane groups are in trans positions while the carbonyl group on the cycloalkanone is in the endo configuration with respect to each of the two norbornane groups. The compound represented by formula (a-2-1b) is an isomer (cis-endo-endo) of the tetracarboxylic dianhydride represented by formula (a-2-1) in which the two norbornane groups are in cis positions while the carbonyl group on the cycloalkanone is in the endo configuration with respect to each of the two norbornane groups. The tetracarboxylic dianhydrides including such isomers with the above content may be produced using any known method, such as the method disclosed in WO 2014/034760.

### [Aminosilane Compound]

The aminosilane compound is a compound represented by formula (a-1):

R^{a1}ₜR^{a2}₍₃₋ₜ₎Si—R^{a3}—NH₂ (a-1)

wherein, R^{a1} is a group capable of undergoing hydrolysis to produce a silanol group, R^{a2} is an optionally substituted hydrocarbon group, R^{a3} is an aliphatic chain group, and t is 2 or 3.

In formula (a-1), R^{a1} is a group capable of undergoing hydrolysis to produce a silanol group. Examples of the group capable of undergoing hydrolysis to produce a silanol group include an alkoxy group, an isocyanate group, a dimethylamino group, and a halogen atom. Among these groups, an alkoxy group and a halogen atom are preferred, so that the aminosilane compound will be easy to obtain and a good balance can be achieved between the stability and hydrolyzability of the compound in the composition for forming a hard coat.

The alkoxy group is preferably a linear or branched alkoxy group having 1 or more and 4 or less carbon atoms. Preferred examples of the alkoxy group include a methoxy group, an ethoxy group, an n-propoxy group, an isopropoxy group, and an n-butoxy group. Among them, a methoxy group and an ethoxy group are more preferred.

The halogen atom is preferably chlorine, fluorine, bromine, or iodine, more preferably chlorine.

In formula (a-1), R^{a2} is an optionally substituted hydrocarbon group. R^{a2} may be any hydrocarbon group as long as the object of the present invention is not impaired. Examples of the hydrocarbon group include an alkyl group, a cycloalkyl group, an aryl group, and an aralkyl group. The optionally substituted hydrocarbon group for R^{a2} may have any number of carbon atoms as long as the object of the present invention is not impaired. The hydrocarbon group preferably has 1 or more and 20 or less, more preferably 1 or more and 12 or less, even more preferably 1 or more and 8 or less, and further more preferably 1 or more and 6 or less carbon atoms.

The hydrocarbon group for R^{a2} may have a substituent, which may be a hetero atom, such as a halogen atom, or may be a group containing a hetero atom, such as O, N, S, P, Se or halogen. Examples of the substituent which the hydrocarbon group may have include a halogen atom such as fluorine, chlorine, bromine, or iodine; an alkoxy group having 1 or more and 4 or less carbon atoms; an alkylthio group having 1 or more and 4 or less carbon atoms; a phenoxy group; a phenylthio group; an aliphatic acyl group having 2 or more and 5 or less carbon atoms; an aliphatic acyloxy group having 2 or more and 5 or less carbon atoms; a benzoyl group; a benzoyloxy group; and a cyano group.

R^{a2} is preferably an alkyl group, an alkoxyalkyl group, or a phenyl group. Examples of the alkyl group include a methyl group, an ethyl group, an n-propyl group, an isopropyl group, and an n-butyl group. Examples of the alkoxyalkyl group include a methoxymethyl group, a methoxyethyl group, an ethoxymethyl group, and an ethoxyethyl group.

In formula (a-1), R^{a3} is an aliphatic chain group. The aliphatic chain group may be linear or branched. The aliphatic chain group may contain one or more unsaturated bonds. The aliphatic chain group may also contain a hetero atom such as O, N, S, P, Se, or halogen. The aliphatic chain group is preferably an alkylene group, and more preferably a linear alkylene group. The aliphatic chain group may have any number of carbon atoms as long as the object of the present invention is not impaired. The aliphatic chain group preferably has 1 or more and 20 or less, more preferably 1 or more and 10 or less, even more preferably 1 or more and 6 or less, and further more preferably 1 or more and 4 or less carbon atoms.

The aliphatic chain group for R^{a3} is preferably an alkylene group having 1 or more and 10 or less carbon atoms, more preferably a linear alkylene group having 1 or more and 10 or less carbon atoms, even more preferably a linear alkylene group having 1 or more and 6 or less carbon atoms, and further more preferably a linear alkylene group having 1 or more and 4 or less carbon atoms.

Preferred examples of the aliphatic chain group for R^{a3} include a methylene group, an ethane-1,2-diyl (ethylene) group, a propane-1,3-diyl group, a butane-1,4-diyl group, a pentane-1,5-diyl group, a hexane-1,6-diyl group, a heptane-1,7-diyl group, an octane-1,8-diyl group, a nonane-1,9-diyl group, and a decane-1,10-diyl group. Among them, an ethane-1,2-diyl group (ethylene group), a propane-1,3-diyl group, and a butane-1,4-diyl group are more preferred.

In the aminosilane compound represented by formula (a-1), t is preferably 3, R^{a1} is preferably an alkoxy group having 1 or more and 4 or less carbon atoms, and R^{a3} is preferably an alkylene group having 1 or more and 10 or less carbon atoms, for hydrolyzability, crosslinking reactivity, and various properties of the hard coat.

Examples of the reactive silyl group represented by R^{a1}ₜR^{a2}₍₃₋ₜ₎Si— in formula (a-1) are preferably a trimethoxysilyl group, a triethoxysilyl group, a tri-n-propyloxysilyl group, a methyldimethoxysilyl group, an ethyldimethoxysilyl group, a (methoxymethyl)dimethoxysilyl group, a methyldiethoxysilyl group, an ethyldiethoxysilyl group, and a (methoxymethyl)diethoxysilyl group, and more preferably a trimethoxysilyl group and a triethoxysilyl group.

Preferred example of the aminosilane compound represented by formula (a-1) include 3-aminopropyltrimethoxysilane, 3-aminopropyltriethoxysilane, 3-aminopropyltri-n-propyloxysilane, 3-aminopropylmethyldimethoxysilane, 3-aminopropylethyldimethoxysilane, 3-aminopropyl(methoxymethyl)dimethoxysilane, 3-aminopropylmethyldiethoxysilane, 3-aminopropylethyldiethoxysilane, 3-aminopropyl(methoxymethyl)diethoxysilane, 4-aminobutyltrimethoxysilane, 4-aminobutyltriethoxysilane, 4-aminobutyltri-n-propyloxysilane, 4-aminobutylmethyldimethoxysilane, 4-aminobutylethyldimethoxysilane, 4-aminobutyl(methoxymethyl)dimethoxysilane, 4-aminobutylmethyldiethoxysilane, 4-aminobutylethyldiethoxysilane, 4-aminobutyl(methoxymethyl)diethoxysilane, 2-aminoethyltrimethoxysilane, 2-aminoethyltriethoxysilane, 2-aminoethyltri-n-propyloxysilane, 2-aminoethylmethyldimethoxysilane, 2-aminoethylethyldimethoxysilane, 2-aminoethyl(methoxymethyl)dimethoxysilane, 2-aminoethylmethyldiethoxysilane, 2-aminoethylethyldiethoxysilane, and 2-aminoethyl(methoxymethyl)diethoxysilane.

Among these aminosilane compounds, 3-aminopropyltrimethoxysilane, 3-aminopropyltriethoxysilane, 4-aminobutyltrimethoxysilane, 4-aminobutyltriethoxysilane, 2-aminoethyltrimethoxysilane, and 2-aminoethyltriethoxysilane are more preferred for ease of availability and the properties of the hard coat.

The composition for forming a hard coat preferably contains a compound represented by formula (a-I) below only as a silane-modified alicyclic compound, or preferably contains, as a silane-modified alicyclic compound, a combination of a compound represented by formula (a-I) below and a compound represented by formula (a-II-1) below and/or a compound represented by formula (a-II-2) below.

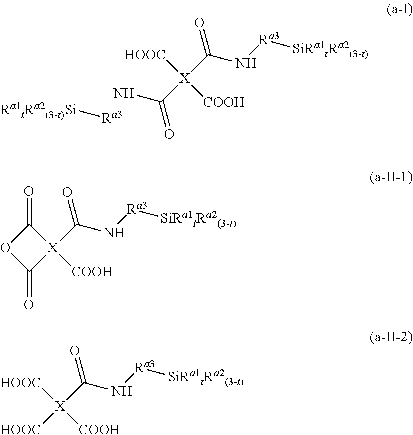

In formulas (a-I), (a-II-1), and (a-II-2), R^{a1} is a group capable of undergoing hydrolysis to produce a silanol group, R^{a2} is an optionally substituted hydrocarbon group, R^{a3} is an aliphatic chain group, t is 2 or 3, and X is a tetravalent aliphatic group containing an alicyclic skeleton.

In formulas (a-I), (a-II-1), and (a-II-2), R^{a1}, R^{a2}, R^{a3}, and t are the same as defined for formula (a-1). In formulas (a-I), (a-II-1), and (a-II-2), the tetravalent aliphatic group for X containing an alicyclic skeleton may be considered as a tetravalent group derived from the above alicyclic tetracarboxylic dianhydride by removal of two carboxylic anhydride groups.

The compound represented by formula (a-I), (a-II-1), or (a-II-2) can be produced by reaction of the aminosilane compound represented by formula (a-1) above with the above alicyclic tetracarboxylic dianhydride. In particular, the aminosilane compound may be reacted with the alicyclic tetracarboxylic dianhydride in the presence of water to form the compound represented by formula (a-II-2).

Only the compound represented by formula (a-I) may be used to form the composition for forming a hard coat. In this case, the alicyclic tetracarboxylic dianhydride may be reacted with a large excess of the compound represented by formula (a-1) so that the compound represented by formula (a-I) can be selectively produced.

A combination of the compound represented by formula (a-I) and the compound represented by formula (a-II-1) and/or the compound represented by formula (a-II-2) may be used to form the composition for forming a hard coat. In this case, the compound represented by formula (a-I) and the compound represented by formula (a-II-1) and/or the compound represented by formula (a-II-2) may be synthesized at the same time or may be separately synthesized and then mixed as needed. The compound represented by formula (a-I) and the compound represented by formula (a-II-1) and/or the compound represented by formula (a-II-2) are preferably synthesized at the same time, so that complicated purification or mixing operation can be avoided.

When the compound represented by formula (a-I) and the compound represented by formula (a-II-1) and/or the compound represented by formula (a-II-2) are synthesized at the same time, the aminosilane compound is preferably used in an amount of 0.7 parts by mole or more and 2.5 parts by mole or less, more preferably 1.0 part by mole or more and 2.3 parts by mole or less, and even more preferably 1.5 parts by mole or more and 2.2 parts by mole or less, based on 1 part by mole of the alicyclic tetracarboxylic dianhydride.

For the hardness, transparency, and other properties of the hard coat, the compound represented by formula (a-I) is preferably represented by formula (a-I-a). The compound represented by formula (a-II-1) is preferably represented by formula (a-II-a). The compound represented by formula (a-II-2) is preferably represented by formula (a-II-b).

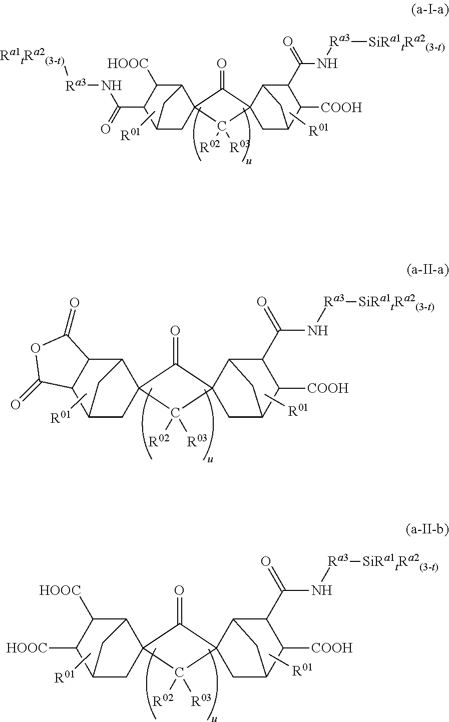

In formulas (a-I-a), (a-II-a), and (a-II-b), R^{a1} is a group capable of undergoing hydrolysis to produce a silanol group, R^{a2} is an optionally substituted hydrocarbon group, R^{a3} is an aliphatic chain group, t is 2 or 3, R⁰¹, R⁰², and R⁰³ each independently represent one selected from the group consisting of a hydrogen atom, an alkyl group having 1 or more and 10 or less carbon atoms, and a fluorine atom, and u represents an integer of 0 or more and 12 or less.

In formulas (a-I-a), (a-II-a), and (a-II-b), R^{a1}, R^{a2}, R^{a3}, and t are the same as defined for formula (a-1). In formulas (a-I-a), (a-II-a), and (a-II-b), R⁰¹, R⁰², R⁰³, and u are the same as defined for formula (a-2-1).

In formulas (a-I), (a-II-1), and (a-II-2), t is preferably 3, R^{a1} is preferably an alkoxy group having 1 or more and 4 or less carbon atoms, and R^{a3} is preferably an alkylene group having 1 or more and 10 or less carbon atoms, for hydrolyzability, crosslinking reactivity, and various properties of the hard coat.

The mass content of the silane-modified alicyclic compound based on the mass of the components, other than a solvent (described later), of the composition for forming a hard coat is preferably 50% by mass or more, more preferably 70% by mass or more, even more preferably 80% by mass or more, and further more preferably 90% by mass or more, so that it will be easy to form a densely crosslinked hard coat with high hardness.

### <Other Components Capable of Undergoing Condensation Reaction>

Besides the silane-modified alicyclic compound described above, the composition for forming a hard coat may contain other components capable of undergoing condensation reaction with the silane-modified alicyclic compound. Such other components capable of undergoing condensation include a silyl group-modified resin having a silyl group represented by R^{a1}ₜR^{a2}₍₃₋ₜ₎Si—. R^{a1}, R^{a2}, and t are the same as defied above. Examples of the silyl group-modified resin include a silyl group-modified acrylic resin having an introduced silyl group and a silyl group-modified polyoxyalkylene resin. Such other components capable of undergoing condensation also preferably include partial hydrolysis-condensation products of silane compounds such as tetramethoxysilane, tetraethoxysilane, methyltrimethoxysilane, ethyltrimethoxysilane, dimethyldimethoxysilane, dimethyldiethoxysilane, diethyldimethoxysilane, and diethyldiethoxysilane.

In the composition for forming a hard coat, the mass content of the silane-modified alicyclic compound based on the total mass of the silane-modified alicyclic compound and the other components capable of undergoing condensation is preferably 50% by mass or more, more preferably 70% by mass or more, even more preferably 80% by mass or more, further more preferably 90% by mass or more, still more preferably 95% by mass or more, and most preferably 100% by mass.

### <Acid Generator and Curing Catalyst>

The composition for forming a hard coat may contain an acid generator and/or a curing catalyst for the purpose of facilitating curing upon exposure to light or heating at low temperature.

### [Acid Generator]

The acid generator may be any one or a combination of a photoacid generator (A1) and a thermal acid generator (A2). The photoacid generator (A1) and the thermal acid generator (A2) may be known compounds.

For example, the photoacid generator (A1) is preferably an onium salt having a cationic moiety represented by formula (ai) below.

(R^{a01})ₚ₊₁—R^{a02+} (ai)

In formula (ai), each R^{a01} is independently a monovalent organic group, R^{a02} is an element with a valence of p belonging to Groups 15 to 17 of the IUPAC Periodic Table of the Elements, and at least one of R^{a01} is an optionally substituted aryl group. The thermal acid generator (A2) is preferably an onium salt having an anionic moiety represented by formula (Ai) below.

(R^{A1})₄—Ga⁻ (Ai)

In formula (Ai), each R^{A1} is independently a phenyl group optionally having one or more substituents or a perfluoroalkyl group.

The photoacid generator (A1) having a cationic moiety represented by formula (ai) and the thermal acid generator (A2) having an anionic moiety represented by formula (Ai) can be used in combination to enhance the curing properties of the composition for forming a hard coat and to prevent discoloration of the hard coat during curing. When an onium salt-type photoacid generator (A1) is used to cure the composition, the resulting hard coat may be discolored due to a discoloring substance produced when the photoacid generator (A1) is decomposed by exposure to light. In this regard, the following can be considered. When the specific thermal acid generator (A2) is decomposed by heating, the photoacid generator (A1) can be prevented from producing a discoloring substance, which would otherwise be formed by the decomposition of the photoacid generator (A), or the decomposition product of the thermal acid generator (A2) can have some sort of effect on any discoloring substance to suppress the discoloration of the hard coat during curing.

### [Photoacid Generator (A1)]

Hereinafter, the photoacid generator (A1) will be described. The photoacid generator (A1) may be any type. The photoacid generator (A1) is preferably an onium salt having a cationic moiety represented by formula (ai) below. The anionic moiety in the onium salt as the photoacid generator (A1) may be any type as long as the object of the present invention is not impaired.

(R^{a01})ₚ₊₁—R^{a02+} (ai)

In formula (ai), each R^{a01} is independently a monovalent organic group, R^{a02} is an element with a valence of p belonging to Groups 15 to 17 of the IUPAC Periodic Table of the Elements, and at least one of R^{a01} is an optionally substituted aryl group.

In formula (ai) representing a cationic moiety, R^{a01} represents an organic group bonded to R^{a02}. A plurality of R^{a01}, if any, may be the same or different. Examples of R^{a01} include an optionally substituted aryl group having 6 or more and 14 or less carbon atoms (aromatic hydrocarbon group), an optionally substituted alkyl group having 1 or more and 18 or less carbon atoms, an optionally substituted aralkyl group having 7 or more and 12 or less carbon atoms, an optionally substituted alkenyl group having 2 or more and 18 or less carbon atoms, and an optionally substituted alkynyl group having 2 or more and 18 or less carbon atoms. In the photoacid generator (A1) having a cation represented by formula (ai) as a cationic moiety, R^{a01} is preferably an aryl group having 6 or more and 14 or less carbon atoms, an alkyl group having 1 or more and 18 or less carbon atoms, an alkenyl group having 2 or more and 18 or less carbon atoms, or an alkynyl group having 2 or more and 18 or less carbon atoms.

Examples of the substituent optionally possessed by the aryl group, the aralkyl group, the alkyl group, the alkenyl group, and the alkynyl group for R^{a01} include an alkynyl group having 1 or more and 18 or less carbon atoms, a halogenated alkyl group having 1 or more and 18 or less carbon atoms, an aliphatic cyclic group having 3 or more and 18 or less carbon atoms, a halogenated aliphatic cyclic group having 3 or more and 18 or less carbon atoms, an alkenyl group having 2 or more and 18 or less carbon atoms, an alkynyl group having 2 or more and 18 or less carbon atoms, an aryl group having 6 or more and 14 or less carbon atoms, a nitro group, a hydroxyl group, a cyano group, an alkoxy group having 1 or more and 18 or less carbon atoms, an aryloxy group having 6 or more and 14 or less carbon atoms, an aliphatic acyl group having 2 or more and 19 or less carbon atoms, an aromatic acyl group having 7 or more and 15 or less carbon atoms, an aliphatic acyloxy group having 2 or more and 19 or less carbon atoms, an aromatic acyloxy group having 7 or more and 15 or less carbon atoms, an alkylthio group having 1 or more and 18 or less carbon atoms, an arylthio group having 6 or more and 14 or less carbon atoms, an amino group with one or two nitrogen-bonding hydrogen atoms optionally replaced by a hydrocarbon group(s) having 1 or more and 18 or less carbon atoms, and a halogen atom.

Among these substituents, an alkyl group, a halogenated alkyl group, an aliphatic cyclic group, a halogenated aliphatic cyclic group, an alkoxy group, an aryloxy group, an aliphatic acyl group, an aromatic acyl group, an aliphatic acyloxy group, an aromatic acyloxy group, an alkylthio group, an arylthio group, and an amino group optionally substituted with a hydrocarbon group are preferred.

When the aryl group, the aralkyl group, the alkyl group, the alkenyl group, and the alkynyl group for R^{a01} are optionally substituted with an alkyl group, preferred examples of such an alkyl group include linear alkyl groups such as a methyl group, an ethyl group, an n-propyl group, an n-butyl group, an n-pentyl group, an n-hexyl group, an n-octyl group, an n-nonyl group, an n-decyl group, an n-undecyl group, an n-dodecyl group, an n-tridecyl group, an n-tetradecyl group, an n-pentadecyl group, an n-hexadecyl group, an n-heptadecyl group, and an n-octadecyl group; and branched alkyl groups such as an isopropyl group, an isobutyl group, a sec-butyl group, a tert-butyl group, an isopentyl group, a neopentyl group, a tert-pentyl group, an isohexyl group, a 2-ethylhexyl group, and a 1,1,3,3-tetramethylbutyl group.

When the aryl group, the aralkyl group, the alkyl group, the alkenyl group, and the alkynyl group for R^{a01} are optionally substituted with a halogenated alkyl group, preferred examples of such a halogenated alkyl group include linear halogenated alkyl groups such as a trifluoromethyl group, a trichloromethyl group, a pentafluoroethyl group, a 2,2,2-trichloroethyl group, a 2,2,2-trifluoroethyl group, a 1,1-difluoroethyl group, a heptafluoro-n-propyl group, a 1,1-difluoro-n-propyl group, a 3,3,3-trifluoro-n-propyl group, a nonafluoro-n-butyl group, a 3,3,4,4,4-pentafluoro-n-butyl group, a perfluoro-n-pentyl group, and a perfluoro-n-octyl group; and branched halogenated alkyl groups such as a hexafluoroisopropyl group, a hexachloroisopropyl group, a hexafluoroisobutyl group, and a nonafluoro-tert-butyl group.

When the aryl group, the aralkyl group, the alkyl group, the alkenyl group, and the alkynyl group for R^{a01} are optionally substituted with an aliphatic cyclic group, preferred examples of such an aliphatic cyclic group include a cyclopropyl group, a cyclobutyl group, a cyclopentyl group, a cyclohexyl group, and an adamantyl group.

When the aryl group, the aralkyl group, the alkyl group, the alkenyl group, and the alkynyl group for R^{a01} are optionally substituted with a halogenated aliphatic cyclic group, preferred examples of such a halogenated aliphatic cyclic group include a pentafluorocyclopropyl group, a nonafluorocyclobutyl group, a perfluorocyclopentyl group, a perfluorocyclohexyl group, and a perfluoroadamantyl group.

When the aryl group, the aralkyl group, the alkyl group, the alkenyl group, and the alkynyl group for R^{a01} are optionally substituted with an alkoxy group, preferred examples of such an alkoxy group include linear alkoxy groups such as a methoxy group, an ethoxy group, an n-propyloxy, an n-butyloxy group, an n-pentyloxy group, an n-hexyloxy group, an n-octyloxy group, an n-nonyloxy group, an n-decyl group, an n-undecyloxy group, an n-dodecyloxy group, an n-tridecyloxy group, an n-tetradecyloxy group, an n-pentadecyloxy group, an n-hexadecyloxy group, an n-heptadecyloxy group, and an n-octadecyloxy group; and branched alkoxy groups such as an isopropyloxy group, an isobutyloxy group, a sec-butyloxy group, a tert-butyloxy group, an isopentyloxy group, a neopentyloxy group, a tert-pentyloxy group, an isohexyloxy group, a 2-ethylhexyloxy group, and a 1,1,3,3-tetramethylbutyloxy group.

When the aryl group, the aralkyl group, the alkyl group, the alkenyl group, and the alkynyl group for R^{a01} are optionally substituted with an aryloxy group, preferred examples of such an aryloxy group include a phenoxy group, an α-naphthyloxy group, a β-naphthyloxy group, a biphenyl-4-yloxy group, a biphenyl-3-yloxy group, a biphenyl-2-yloxy group, an anthryloxy group, and a phenanthryloxy group.

When the aryl group, the aralkyl group, the alkyl group, the alkenyl group, and the alkynyl group for R^{a01} are optionally substituted with an aliphatic acyl group, preferred examples of such an aliphatic acyl group include an acetyl group, a propanoyl group, a butanoyl group, a pentanoyl group, a hexanoyl group, a heptanoyl group, and an octanoyl group.

When the aryl group, the aralkyl group, the alkyl group, the alkenyl group, and the alkynyl group for R^{a01} are optionally substituted with an aromatic acyl group, preferred examples of such an aromatic acyl group include a benzoyl group, an α-naphthoyl group, a β-naphthoyl group, a biphenyl-4-ylcarbonyl group, a biphenyl-3-ylcarbonyl group, a biphenyl-2-ylcarbonyl group, an anthrylcarbonyl group, and a phenanthrylcarbonyl group.

When the aryl group, the aralkyl group, the alkyl group, the alkenyl group, and the alkynyl group for R^{a01} are optionally substituted with an aliphatic acyloxy group, preferred examples of such an aliphatic acyloxy group include an acetyloxy group, a propanoyloxy group, a butanoyloxy group, a pentanoyloxy group, a hexanoyloxy group, a heptanoyloxy group, and an octanoyloxy group.

When the aryl group, the aralkyl group, the alkyl group, the alkenyl group, and the alkynyl group for R^{a01} are optionally substituted with an aromatic acyloxy group, preferred examples of such an aromatic acyloxy group include a benzoyloxy group, an α-naphthoyloxy group, a β-naphthoyloxy group, a biphenyl-4-ylcarbonyloxy group, a biphenyl-3-ylcarbonyloxy group, a biphenyl-2-ylcarbonyloxy group, an anthrylcarbonyloxy group, and a phenanthrylcarbonyloxy group.

When the aryl group, the aralkyl group, the alkyl group, the alkenyl group, and the alkynyl group for R^{a01} are optionally substituted with an alkylthio or arylthio group, preferred examples of such an alkylthio or arylthio group include groups derived from the above preferred alkoxy or aryloxy groups by replacing an oxygen atom with a sulfur atom.

When the aryl group, the aralkyl group, the alkyl group, the alkenyl group, and the alkynyl group for R^{a01} are optionally substituted with an amino group optionally substituted with a hydrocarbon group, preferred examples of such an amino group optionally substituted with a hydrocarbon group include an amino group, a methylamino group, an ethylamino group, an n-propylamino group, a dimethylamino group, a diethylamino group, a methylethylamino group, a di-n-propylamino group, and a piperidino group.

When the aryl group, the aralkyl group, the alkyl group, the alkenyl group, and the alkynyl group for R^{a01} are optionally substituted with a halogen atom, preferred examples of such a halogen atom include fluorine, chlorine, bromine, and iodine.

Among the above substituents, a halogenated alkyl group having 1 or more and 8 or less carbon atoms, a halogen atom, a nitro group, and a cyano group are preferred, and a fluorinated alkyl group having 1 or more and 8 or less carbon atoms is more preferred, so that the photoacid generator (A1) can be highly active.

In formula (ai), a plurality of R^{a01}, if any, may form a ring together with R^{a02}. The ring structure that a plurality of R^{a01} and R^{a02} form may contain one or more bonds selected from the group consisting of —O—, —S—, —SO—, —SO₂—, —NH—, —CO—, —COO—, and —CONH—.

In formula (ai), R^{a02} is an element with a valence of p belonging to Groups 15 to 17 of the IUPAC Periodic Table of the Elements. The element for R^{a02} belonging to Groups 15 to 17 of the IUPAC Periodic Table of the Elements is stable under conditions for the production and storage of the composition for forming a hard coat and under conditions for the formation of the hard coat. R^{a02} is bonded to the organic group R^{a01} to form an onium ion. Ra⁰² is preferably sulfur (S), nitrogen (N), iodine (I), or phosphorus (P) among the elements belonging to Groups 15 to 17 of the IUPAC Periodic Table of the Elements. The corresponding onium ions are sulfonium ion, ammonium ion, iodonium ion, and phosphonium ion.
These ions are preferred because they are stable and easy to handle. In particular, sulfonium ion and iodonium ion are more preferred, and sulfonium ion is even more preferred, because they have high crosslinking reactivity. In other words, R^{a02} is preferably sulfur, and p is preferably 2 in formula (ai).

Examples of the sulfonium ion include triarylsulfoniums such as triphenylsulfonium, tri-p-tolylsulfonium, tri-o-tolylsulfonium, tris(4-methoxyphenyl)sulfonium, 1-naphthyldiphenylsulfonium, 2-naphthyldiphenylsulfonium, tris(4-fluorophenyl)sulfonium, tri-1-naphthylsulfonium, tri-2-naphthylsulfonium, tris(4-hydroxyphenyl)sulfonium, 4-(phenylthio)phenyldiphenylsulfonium, 4-(p-tolylthio)phenyldi-p-tolylsulfonium, 4-(4-methoxyphenylthio)phenylbis(4-methoxyphenyl)sulfonium, 4-(phenylthio)phenylbis(4-fluorophenyl)sulfonium, 4-(phenylthio)phenylbis(4-methoxyphenyl)sulfonium, 4-(phenylthio)phenyldi-p-tolylsulfonium, [4-(4-biphenylthio)phenyl]-4-biphenylylphenylsulfonium, [4-(2-thioxanthonylthio)phenyl]diphenylsulfonium, bis[4-(diphenylsulfonio)phenyl]sulfide, bis[4-{bis[4-(2-hydroxyethoxy)phenyl]sulfonio}phenyl]sulfide, bis{4-[bis(4-fluorophenyl)sulfonio]phenyl}sulfide, bis{4-[bis(4-methylphenyl)sulfonio]phenyl}sulfide, bis{4-[bis(4-methoxyphenyl)sulfonio]phenyl}sulfide, 4-(4-benzoyl-2-chlorophenylthio)phenylbis(4-fluorophenyl)sulfonium, 4-(4-benzoyl-2-chlorophenylthio)phenyldiphenylsulfonium, 4-(4-benzoylphenylthio)phenylbis(4-fluorophenyl)sulfonium, 4-(4-benzoylphenylthio)phenyldiphenylsulfonium, 7-isopropyl-9-oxo-10-thia-9,10-dihydroanthracene-2-yldi-p-tolylsulfonium, 7-isopropyl-9-oxo-10-thia-9,10-dihydroanthracene-2-yldiphenylsulfonium, 2-[(di-p-tolyl)sulfonio]thioxanthone, 2-[(diphenyl)sulfonio]thioxanthone, 4-(9-oxo-9H-thioxanthen-2-yl)thiophenyl-9-oxo-9H-thioxanthen-2-ylphenylsulfonium, 4-[4-(4-tert-butylbenzoyl)phenylthio]phenyldi-p-tolylsulfonium, 4-[4-(4-tert-butylbenzoyl)phenylthio]phenyldiphenylsulfonium, 4-[4-(benzoylphenylthio)]phenyldi-p-tolylsulfonium, 4-[4-(benzoylphenylthio)]phenyldiphenylsulfonium, 5-(4-methoxyphenyl)thianthrenium, 5-phenylthianthrenium, 5-tolylthianthrenium, 5-(4-ethoxyphenyl)thianthrenium, and 5-(2,4,6-trimethylphenyl)thianthrenium; diarylsulfoniums such as diphenylphenacylsulfonium, diphenyl-4-nitrophenacylsulfonium, diphenylbenzylsulfonium, and diphenylmethylsulfonium; monoarylsulfoniums such as phenylmethylbenzylsulfonium, 4-hydroxyphenylmethylbenzylsulfonium, 4-methoxyphenylmethylbenzylsulfonium, 4-acetocarbonyloxyphenylmethylbenzylsulfonium, 4-hydroxyphenyl(2-naphthylmethyl)methylsulfonium, 2-naphthylmethylbenzylsulfonium, 2-naphthylmethyl(1-ethoxycarbonyl)ethylsulfonium, phenylmethylphenacylsulfonium, 4-hydroxyphenylmethylphenacylsulfonium, 4-methoxyphenylmethylphenacylsulfonium, 4-acetocarbonyloxyphenylmethylphenacylsulfonium, 2-naphthylmethylphenacylsulfonium, 2-naphthyloctadecylphenacylsulfonium, and 9-anthracenylmethylphenacylsulfonium; and trialkylsulfoniums such as dimethylphenacylsulfonium, phenacyltetrahydrothiophenium, dimethylbenzylsulfonium, benzyltetrahydrothiophenium, and octadecylmethylphenacylsulfonium.

Examples of the ammonium ion include tetraalkylammoniums such as tetramethylammonium, ethyltrimethylammonium, diethyldimethylammonium, triethylmethylammonium, and tetraethylammonium; pyrrolidiniums such as N,N-dimethylpyrrolidinium, N-ethyl-N-methylpyrrolidinium, and N,N-diethylpyrrolidinium; imidazoliniums such as N,N′-dimethylimidazolinium, N,N′-diethylimidazolinium, N-ethyl-N′-methylimidazolinium, 1,3,4-trimethylimidazolinium, and 1,2,3,4-tetramethylimidazolinium; tetrahydropyrimidinium such as N,N′-dimethyl tetrahydropyrimidinium, morpholinium such as N,N′-dimethylmorpholinium; piperidinium such as N,N′-diethylpiperidinium; pyridiniums such as N-methylpyridinium, N-benzylpyridinium, and N-phenacylpyridium; imidazolium such as N,N′-dimethylimidazolium; quinoliums such as N-methylquinolium, N-benzylquinolium, and N-phenacylquinolium; isoquinolium such as N-methylisoquinolium; thiazoniums such as benzylbenzothiazonium and phenacylbenzothiazonium; and acridium such as phenacylacrydium.

Examples of the phosphonium ion include tetraarylphosphoniums such as tetraphenylphosphonium, tetra-p-tolylphosphonium, tetrakis(2-methoxyphenyl)phosphonium, tetrakis(3-methoxyphenyl)phosphonium, and tetrakis(4-methoxyphenyl)phosphonium; triarylphosphoniums such as triphenylbenzylphosphonium, triphenylphenacylphosphonium, triphenylmethylphosphonium, and triphenylbutylphosphonium; and tetraalkylphosphoniums such as triethylbenzylphosphonium, tributylbenzylphosphonium, tetraethylphosphonium, tetrabutylphosphonium, tetrahexylphosphonium, triethylphenacylphosphonium, and tributylphenacylphosphonium.

Examples of the iodonium ion include diphenyliodonium, di-p-tolyliodonium, bis(4-dodecylphenyl)iodonium, bis(4-methoxyphenyl)iodonium, (4-octyloxyphenyl)phenyliodonium, bis(4-decyloxy)phenyliodonium, 4-(2-hydroxytetradecyloxy)phenylphenyliodonium, 4-isopropylphenyl(p-tolyl)iodonium, and 4-isobutylphenyl(p-tolyl)iodonium.

The photoacid generator (A1) may be, for example, a gallium-containing onium salt having an anionic moiety represented by formula (aii) below or a boron-containing onium salt having an anionic moiety represented by formula (aiii) below.

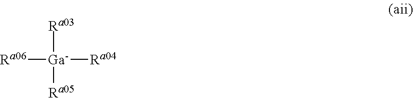

In formula (aii), R^{a03}, R^{a04}, R^{a05}, and R^{a06} are each independently an optionally substituted hydrocarbon group or an optionally substituted heterocyclic group, and at least one of R^{a03}, R^{a04}, R^{a05}, and R^{a06} is an optionally substituted aromatic hydrocarbon group.

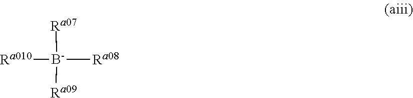

In formula (aiii), R^{a07}, R^{a08}, R^{a09}, and R^{a010} are each independently an optionally substituted hydrocarbon group or an optionally substituted heterocyclic group, and at least one of R^{a07}, R^{a08}, R^{a09}, and R^{a010} is an optionally substituted aromatic hydrocarbon group.

The number of carbon atoms in the hydrocarbon group or the heterocyclic group for R^{a03} to R^{a06} in formula (aii) is preferably, but not limited to, 1 or more and 50 or less, more preferably 1 or more and 30 or less, and even more preferably 1 or more and 20 or less. Examples of the hydrocarbon group for R^{a03} to R^{a06} include a linear or branched alkyl group, a linear or branched alkenyl group, a linear or branched alkynyl group, an aromatic hydrocarbon group, an alicyclic hydrocarbon group, and an aralkyl group. As mentioned above, at least one of R^{a03} to R^{a06} is an optionally substituted aromatic group. More preferably, at least three of R^{a03} to R^{a06} are each an optionally substituted aromatic group, and even more preferably, all of R^{a03} to R^{a06} are each an optionally substituted aromatic group.

Examples of the substituent optionally possessed by the hydrocarbon or heterocyclic group for R^{a03} to R^{a06} include a halogenated alkyl group having 1 or more and 18 or less carbon atoms, a halogenated aliphatic cyclic group having 3 or more and 18 or less carbon atoms, a nitro group, a hydroxyl group, a cyano group, an alkoxy group having 1 or more and 18 or less carbon atoms, an aryloxy group having 6 or more and 14 or less carbon atoms, an aliphatic acyl group having 2 or more and 19 or less carbon atoms, an aromatic acyl group having 7 or more and 15 or less carbon atoms, an aliphatic acyloxy group having 2 or more and 19 or less carbon atoms, an aromatic acyloxy group having 7 or more and 15 or less carbon atoms, an alkylthio group having 1 or more and 18 or less carbon atoms, an arylthio group having 6 or more and 14 or less carbon atoms, an amino group with one or two nitrogen-bonding hydrogen atoms optionally replaced by a hydrocarbon group(s) having 1 or more and 18 or less carbon atoms, and a halogen atom. When the hydrocarbon group for R^{a3} to R^{a6} is an aromatic hydrocarbon group, the aromatic hydrocarbon group may be substituted with one or more substituents selected from the group consisting of an alkyl group having 1 or more and 18 or less carbon atoms, an alkenyl group having 2 or more and 18 or less carbon atoms, and an alkynyl group having 2 or more and 18 or less carbon atoms.

The hydrocarbon group for R^{a03} to R^{a06} may have any number of substituents, such as a single substituent or two or more substituents. The two or more substituents may be the same or different.

Preferred examples of the alkyl group for R^{a03} to R^{a06} include linear alkyl groups such as a methyl group, an ethyl group, an n-propyl group, an n-butyl group, an n-pentyl group, an n-hexyl group, an n-octyl group, an n-nonyl group, an n-decyl group, an n-undecyl group, an n-dodecyl group, an n-tridecyl group, an n-tetradecyl group, an pentadecyl group, an n-hexadecyl group, an n-heptadecyl group, an n-octadecyl group, and an n-nonadecyl group; and branched alkyl groups such as an isopropyl group, an isobutyl group, a sec-butyl group, a tert-butyl group, an isopentyl group, a neopentyl group, a tert-pentyl group, an isohexyl group, a 2-ethylhexyl group, and a 1,1,3,3-tetramethylbutyl group.

Preferred examples of the alkenyl or alkynyl group for R^{a03} to R^{a06} include alkenyl and alkynyl groups corresponding to the preferred alkyl groups listed above.

Preferred examples of the aromatic hydrocarbon group for R^{a03} to R^{a06} include a phenyl group, an α-naphthyl group, a β-naphthyl group, a biphenyl-4-yl group, a biphenyl-3-yl group, a biphenyl-2-yl group, an anthryl group, and a phenanthryl group.

Preferred examples of the alicyclic hydrocarbon group for R^{a03} to R^{a06} include cycloalkyl groups such as a cyclopropyl group, a cyclobutyl group, a cyclopentyl group, a cyclohexyl group, a cyclopentyl group, a cyclooctyl group, a cyclononyl group, and a cyclodecyl group; and bridged aliphatic cyclic hydrocarbon groups such as a norbornyl group, an adamantyl group, a tricyclodecyl group, and a pinanyl group.

Preferred examples of the aralkyl group for R^{a03} to R^{a06} include a benzyl group, a phenethyl group, an α-naphthylmethyl group, a β-naphthylmethyl group, an α-naphthylethyl group, and a β-naphthylethyl group.

Preferred examples of the heterocyclic group for R^{a03} to R^{a06} include a thienyl group, a furanyl group, a selenophenyl group, a pyranyl group, a pyrrolyl group, an oxazolyl group, a thiazolyl group, a pyridyl group, a pyrimidyl group, a pyrazinyl group, an indolyl group, a benzofuranyl group, a benzothienyl group, a quinolyl group, an isoquinolyl group, a quinoxalinyl group, a quinazolinyl group, a carbazolyl group, an acridinyl group, a phenothiazinyl group, a phenazinyl group, a xanthenyl group, a thianthrenyl group, a phenoxazinyl group, a phenoxathiynyl group, a chromanyl group, an isochromanyl group, a dibenzothienyl group, a xanthonyl group, a thioxanthonyl group, and a dibenzofuranyl group.

Examples of R^{a07} to R^{a010} in formula (aiii) include those listed above for R^{a03} to R^{a06} in formula (aii).

Preferred examples of the anionic moiety represented by formula (aii) described above include tetrakis(4-nonafluorobiphenyl)gallium anion, tetrakis(1-heptafluoronaphthyl)gallium anion, tetrakis(pentafluorophenyl)gallium anion, tetrakis(3,4,5-trifluorophenyl)gallate anion, tetrakis(2-nonaphenylbiphenyl)gallium anion, tetrakis(2-heptafluoronaphthyl)gallium anion, tetrakis(7-nonafluoroanthryl)gallium anion, tetrakis(4′-(methoxy)octafluorobiphenyl)gallium anion, tetrakis(2,4,6-tris(trifluoromethyl)phenyl)gallium anion, tetrakis(3,5-bis(trifluoromethyl)phenyl)gallium anion, tetrakis(2,3-bis(pentafluoroethyl)naphthyl)gallium anion, tetrakis(2-isopropoxy-hexafluoronaphthyl)gallium anion, tetrakis(9,10-bis(heptafluoropropyl)heptafluoroanthryl)gallium anion, tetrakis(9-nonafluorophenanthryl)gallate anion, tetrakis(4-[tri(isopropyl)silyl]-tetrafluorophenyl)gallium anion, tetrakis(9,10-bis(p-tolyl)-heptafluorophenanthryl)gallium anion, tetrakis(4-[dimethyl(tert-butyl)silyl]-tetrafluorophenyl)gallium anion, monophenyltris(pentafluorophenyl)gallium anion, and monoperfluorobutyltris(pentafluorophenyl)gallium anion. More preferred examples include the following anions.

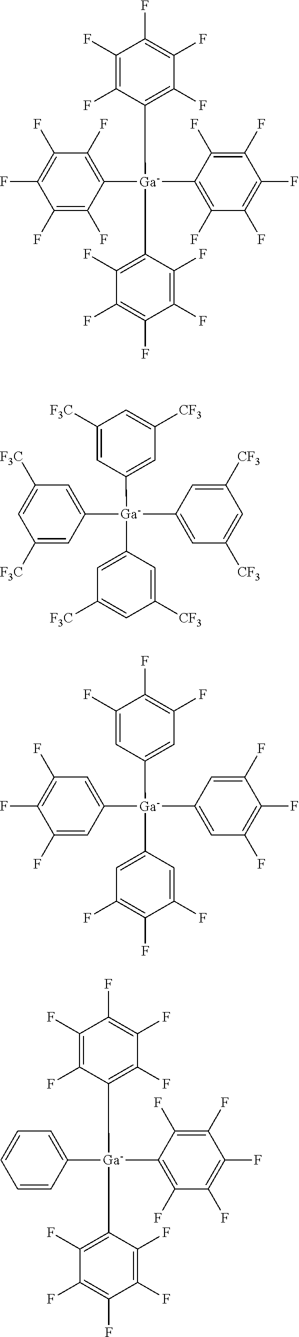

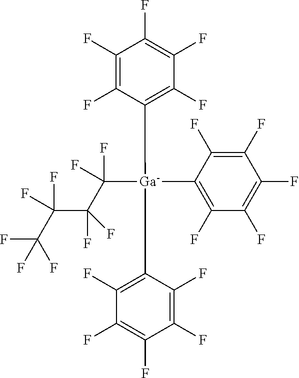

Preferred examples of the anionic moiety represented by formula (aiii) include tetrakis(4-nonafluorobiphenyl)boron anion, tetrakis(1-heptafluoronaphthyl)boron anion, tetrakis(pentafluorophenyl)boron anion, tetrakis(3,4,5-trifluorophenyl)boron anion, tetrakis(2-nonaphenylbiphenyl)boron anion, tetrakis(2-heptafluoronaphthyl)boron anion, tetrakis(7-nonafluoroanthryl)boron anion, tetrakis(4′-(methoxy)octafluorobiphenyl)boron anion, tetrakis(2,4,6-tris(trifluoromethyl)phenyl)boron anion, tetrakis(3,5-bis(trifluoromethyl)phenyl)boron anion, tetrakis(2,3-bis(pentafluoroethyl)naphthyl)boron anion, tetrakis(2-isopropoxy-hexafluoronaphthyl)boron anion, tetrakis(9,10-bis(heptafluoropropyl)heptafluoroanthryl)boron anion, tetrakis (9-nonafluorophenanthryl)boron anion, tetrakis(4-[tri(isopropyl)silyl]-tetrafluorophenyl)boron anion, tetrakis(9,10-bis(p-tolyl)-heptafluorophenanthryl)boron anion, tetrakis(4-[dimethyl(tert-butyl)silyl]-tetrafluorophenyl)boron anion, monophenyltris(pentafluorophenyl)boron anion, and monoperfluorobutyltris(pentafluorophenyl)boron anion. More preferred examples include the following anions.

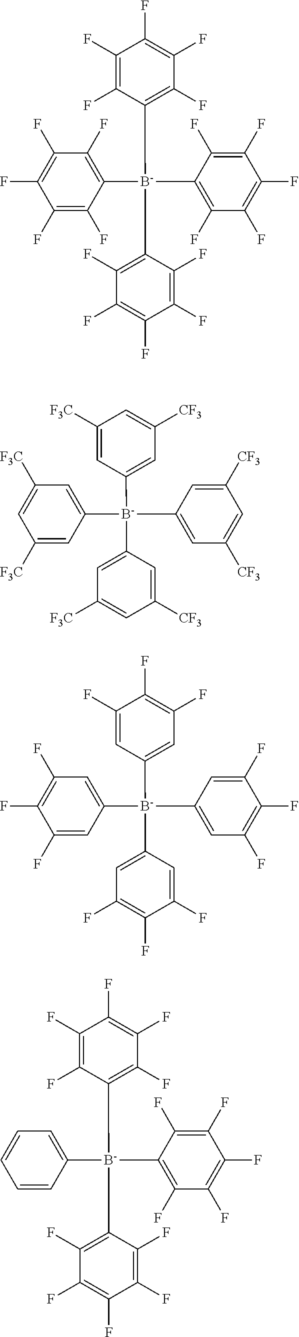 [SMILES: Fc1c(F)c(F)c([B-](c2c(F)c(F)c(F)c(F)c2F)(c2c(F)c(F)c(F)c(F)c2F)c2c(F)c(F)c(F)c(F)c2F)c(F)c1F ; FC(F)(F)c1cc([B-](c2cc(C(F)(F)F)cc(C(F)(F)F)c2)(c2cc(C(F)(F)F)cc(C(F)(F)F)c2)c2cc(C(F)(F)F)cc(C(F)(F)F)c2)cc(C(F)(F)F)c1 ; Fc1cc([B-](c2cc(F)c(F)c(F)c2)(c2cc(F)c(F)c(F)c2)c2cc(F)c(F)c(F)c2)cc(F)c1F ; Fc1c(F)c(F)c([B-](c2ccccc2)(c2c(F)c(F)c(F)c(F)c2F)c2c(F)c(F)c(F)c(F)c2F)c(F)c1F]

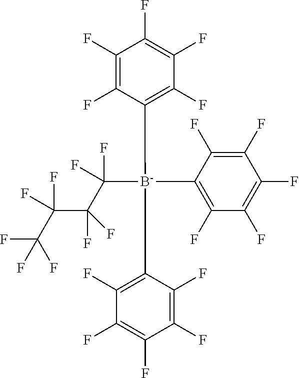 [SMILES: Fc1c(F)c(F)c([B-](c2c(F)c(F)c(F)c(F)c2F)(c2c(F)c(F)c(F)c(F)c2F)C(F)(F)C(F)(F)C(F)(F)C(F)(F)F)c(F)c1F]

Preferred examples of the cationic moiety represented by formula (ai) described above include iodonium ions such as 4-isopropylphenyl(p-tolyl)iodonium and 4-isobutylphenyl(p-tolyl)iodonium; and thioxanthone skeleton-containing sulfonium ions such as [4-(2-thioxanthonylthio)phenyl]diphenylsulfonium, 2-[(di-p-tolyl)sulfonio]thioxanthone, 2-[(diphenyl)sulfonio]thioxanthone, and 4-(9-oxo-9H-thioxanthen-2-yl)thiophenyl-9-oxo-9H-thioxanthen-2-ylphenylsulfonium;
specifically cationic moieties represented by formula (a1) described later; and
other sulfonium ions shown below.

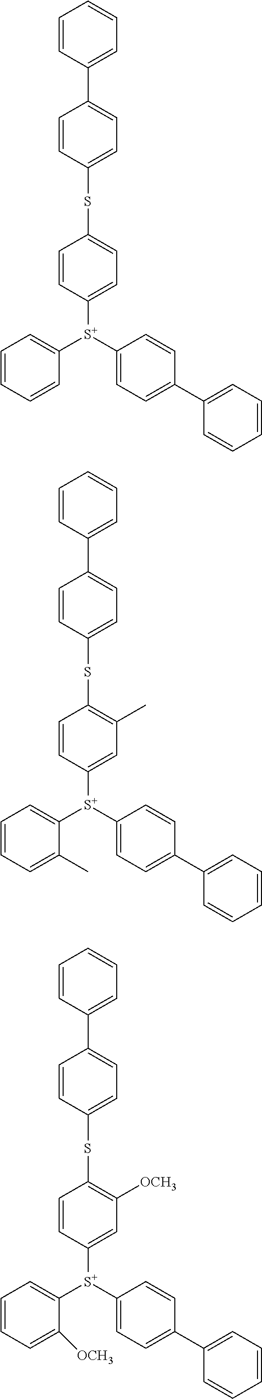 [SMILES: c1ccc(-c2ccc(Sc3ccc([S+](c4ccccc4)c4ccc(-c5ccccc5)cc4)cc3)cc2)cc1 ; Cc1cc([S+](c2ccc(-c3ccccc3)cc2)c2ccccc2C)ccc1Sc1ccc(-c2ccccc2)cc1 ; COc1cc([S+](c2ccc(-c3ccccc3)cc2)c2ccccc2OC)ccc1Sc1ccc(-c2ccccc2)cc1]

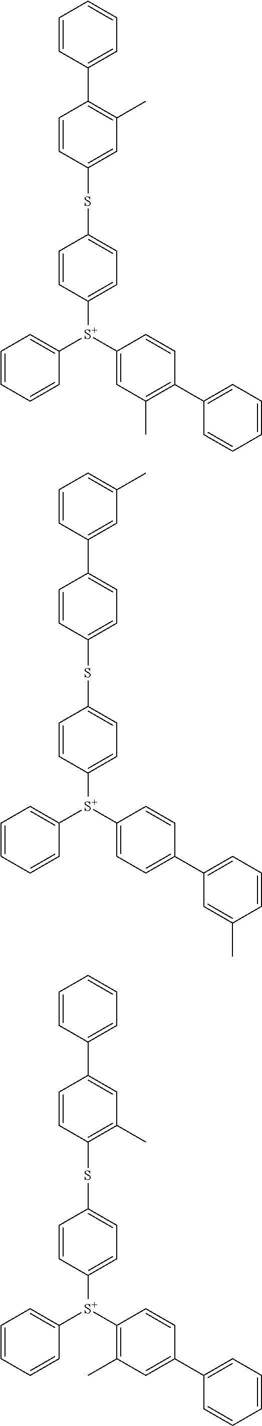 [SMILES: Cc1cc(Sc2ccc([S+](c3ccccc3)c3ccc(-c4ccccc4)c(C)c3)cc2)ccc1-c1ccccc1 ; Cc1cccc(-c2ccc(Sc3ccc([S+](c4ccccc4)c4ccc(-c5cccc(C)c5)cc4)cc3)cc2)c1 ; Cc1cc(-c2ccccc2)ccc1Sc1ccc([S+](c2ccccc2)c2ccc(-c3ccccc3)cc2C)cc1]

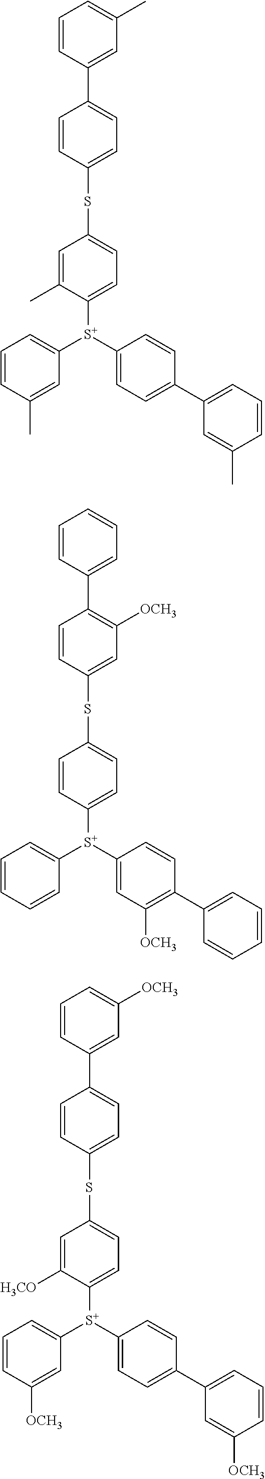 [SMILES: Cc1cccc(-c2ccc(Sc3ccc([S+](c4ccc(-c5cccc(C)c5)cc4)c4cccc(C)c4)c(C)c3)cc2)c1 ; COc1cc(Sc2ccc([S+](c3ccccc3)c3ccc(-c4ccccc4)c(OC)c3)cc2)ccc1-c1ccccc1 ; COc1cccc(-c2ccc(Sc3ccc([S+](c4ccc(-c5cccc(OC)c5)cc4)c4cccc(OC)c4)c(OC)c3)cc2)c1]

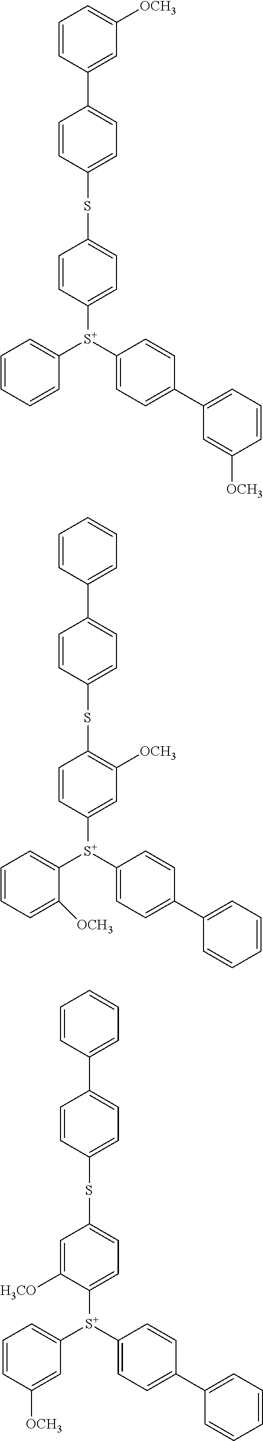 [SMILES: COc1cccc(-c2ccc(Sc3ccc([S+](c4ccccc4)c4ccc(-c5cccc(OC)c5)cc4)cc3)cc2)c1 ; COc1cc([S+](c2ccc(-c3ccccc3)cc2)c2ccccc2OC)ccc1Sc1ccc(-c2ccccc2)cc1 ; COc1cccc([S+](c2ccc(-c3ccccc3)cc2)c2ccc(Sc3ccc(-c4ccccc4)cc3)cc2OC)c1]

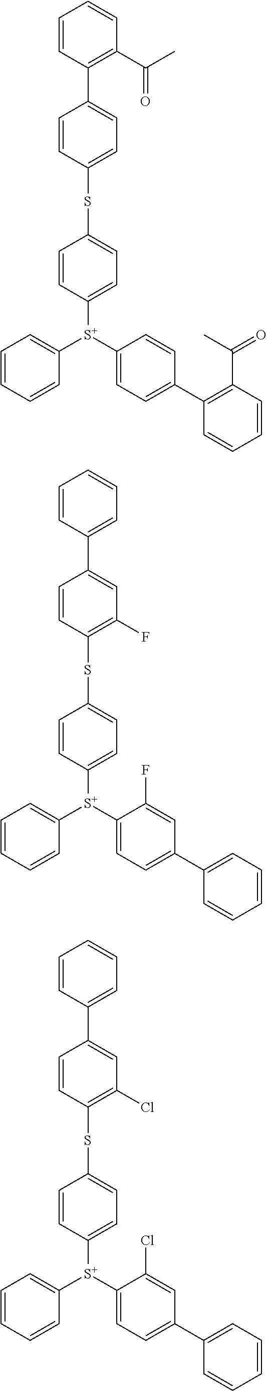 [SMILES: CC(=O)c1ccccc1-c1ccc(Sc2ccc([S+](c3ccccc3)c3ccc(-c4ccccc4C(C)=O)cc3)cc2)cc1 ; Fc1cc(-c2ccccc2)ccc1Sc1ccc([S+](c2ccccc2)c2ccc(-c3ccccc3)cc2F)cc1 ; Clc1cc(-c2ccccc2)ccc1Sc1ccc([S+](c2ccccc2)c2ccc(-c3ccccc3)cc2Cl)cc1]

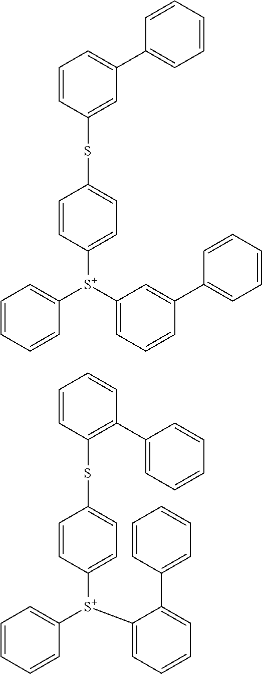 [SMILES: c1ccc(-c2cccc(Sc3ccc([S+](c4ccccc4)c4cccc(-c5ccccc5)c4)cc3)c2)cc1 ; c1ccc(-c2ccccc2Sc2ccc([S+](c3ccccc3)c3ccccc3-c3ccccc3)cc2)cc1]

As mentioned above, the photoacid generator (A1) also preferably has a cationic moiety represented by formula (a1) below. The photoacid generator (A1) in the form of an onium salt having a cationic moiety represented by formula (a1) has high sensitivity. When containing the photoacid generator (A1) in the form of an onium salt having a cationic moiety represented by formula (a1), the composition for forming a hard coat can easily undergo successful curing.

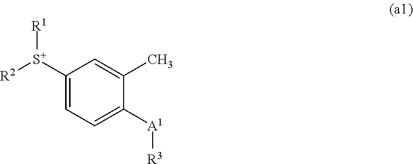

In formula (a1), R¹ and R² each independently represent an optionally halogen-substituted alkyl group or a group represented by formula (a2) below, R¹ and R² may be bonded to each other to form a ring together with the sulfur atom in the formula, R³ represents a group represented by formula (a3) below or a group represented by formula (a4) below, and A¹ represents S, O, or Se, provided that R¹ and R² are not simultaneously an optionally halogen-substituted alkyl group.

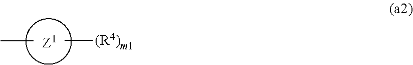

In formula (a2), ring Z¹ represents an aromatic hydrocarbon ring, R⁴ represents an optionally halogen-substituted alkyl group, a hydroxy group, an alkoxy group, an alkylcarbonyl group, an alkoxycarbonyl group, an acyloxy group, an alkylthio group, a thienyl group, a thienylcarbonyl group, a furanyl group, a furanylcarbonyl group, a selenophenyl group, a selenophenylcarbonyl group, a heterocyclic aliphatic hydrocarbon group, an alkylsulfinyl group, an alkylsulfonyl group, a hydroxy(poly)alkyleneoxy group, an optionally substituted amino group, a cyano group, a nitro group, or a halogen atom, and m1 represents an integer of 0 or more.

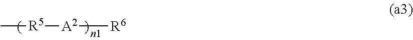

In formula (a3), R⁵ represents a hydroxy group, an alkoxy group, an alkylcarbonyl group, an arylcarbonyl group, an alkoxycarbonyl group, an aryloxycarbonyl group, an arylthiocarbonyl group, an acyloxy group, an arylthio group, an alkylthio group, an aryl group, a heterocyclic hydrocarbon group, an aryloxy group, an alkylsulfinyl group, an arylsulfinyl group, an alkylsulfonyl group, an arylsulfonyl group, a hydroxy(poly)alkyleneoxy group, an optionally substituted amino group, a cyano group, a nitro group, an optionally halogen-substituted alkylene group, or a group represented by formula (a5) below, R⁶ represents a hydroxy group, an alkoxy group, an alkylcarbonyl group, an arylcarbonyl group, an alkoxycarbonyl group, an aryloxycarbonyl group, an arylthiocarbonyl group, an acyloxy group, an arylthio group, an alkylthio group, an aryl group, a heterocyclic hydrocarbon group, an aryloxy group, an alkylsulfinyl group, an arylsulfinyl group, an alkylsulfonyl group, an arylsulfonyl group, a hydroxy(poly)alkyleneoxy group, an optionally substituted amino group, a cyano group, a nitro group, an optionally halogen-substituted alkyl group, or a group represented by formula (a6) below, A² represents a single bond, S, O, a sulfinyl group, or a carbonyl group, and n1 represents 0 or 1.

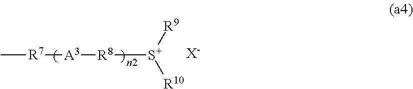

In formula (a4), R⁷ and R⁸ each independently represent a hydroxy group, an alkoxy group, an alkylcarbonyl group, an arylcarbonyl group, an alkoxycarbonyl group, an aryloxycarbonyl group, an arylthiocarbonyl group, an acyloxy group, an arylthio group, an alkylthio group, an aryl group, a heterocyclic hydrocarbon group, an aryloxy group, an alkylsulfinyl group, an arylsulfinyl group, an alkylsulfonyl group, an arylsulfonyl group, a hydroxy(poly)alkyleneoxy group, an optionally substituted amino group, a cyano group, a nitro group, an optionally halogen-substituted alkylene group, or a group represented by formula (a5) below, R⁹ and R¹⁰ each independently represent an optionally halogen-substituted alkyl group or a group represented by formula (a2) above, R⁹ and R¹⁰ may be bonded to each other to form a ring together with the sulfur atom in the formula, A³ represents a single bond, S, O, a sulfinyl group, or a carbonyl group, X⁻ represents a monovalent anion, and n2 represents 0 or 1, provided that R⁹ and R¹⁰ are not simultaneously an optionally halogen-substituted alkyl group.

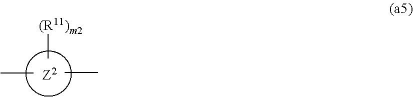

In formula (a5), ring Z² represents an aromatic hydrocarbon ring, R¹¹ represents an optionally halogen-substituted alkyl group, a hydroxy group, an alkoxy group, an alkylcarbonyl group, an arylcarbonyl group, an alkoxycarbonyl group, an aryloxycarbonyl group, an arylthiocarbonyl group, an acyloxy group, an arylthio group, an alkylthio group, an aryl group, a heterocyclic hydrocarbon group, an aryloxy group, an alkylsulfinyl group, an arylsulfinyl group, an alkylsulfonyl group, an arylsulfonyl group, a hydroxy(poly)alkyleneoxy group, an optionally substituted amino group, a cyano group, a nitro group, or halogen atom, and m2 represents an integer of 0 or more.

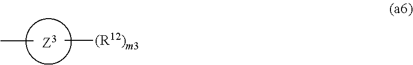

In formula (a6), ring Z³ represents an aromatic hydrocarbon ring, R¹² represents an optionally halogen-substituted alkyl group, a hydroxy group, an alkoxy group, an alkylcarbonyl group, an arylcarbonyl group, an alkoxycarbonyl group, an aryloxycarbonyl group, an arylthiocarbonyl group, an acyloxy group, an arylthio group, an alkylthio group, a thienylcarbonyl group, a furanylcarbonyl group, a selenophenylcarbonyl group, an aryl group, a heterocyclic hydrocarbon group, an aryloxy group, an alkylsulfinyl group, an arylsulfinyl group, an alkylsulfonyl group, an arylsulfonyl group, a hydroxy(poly)alkyleneoxy group, an optionally substituted amino group, a cyano group, a nitro group, or halogen atom, and m3 represents an integer of 0 or more.

The sulfonium salt having a cationic moiety represented by formula (a1) above is characterized in that the methyl group is bonded to the carbon atom in the ortho position with respect to the carbon atom to which A¹ is bonded on the benzene ring in formula (a1) above. The sulfonium salt having the methyl group in such a position can easily generate protons and thus is highly sensitive to actinic energy rays such as ultraviolet rays, as compared to conventional sulfonium salts.

In formula (a1) above, both of R¹ and R² are preferably groups represented by formula (a2) above. R¹ and R² may be the same or different. In formula (a1) above, when R¹ and R² are bonded to each other to form a ring together with the sulfur atom in the formula, the ring is preferably a 3- to 10-membered ring including the sulfur atom, and more preferably a 5- to 7-membered ring. The ring may be polycyclic. Such a polycyclic ring is preferably a fused ring of two or more 5- to 7-membered rings. In formula (a1) above, both R¹ and R² are preferably phenyl groups. In formula (a1) above, R³ is preferably a group represented by formula (a3) above. In formula (a1) above, A¹ is preferably S or O, and more preferably S.

In formula (a2) above, R⁴ is preferably an optionally halogen-substituted alkyl group, a hydroxy group, an alkylcarbonyl group, a thienylcarbonyl group, a furanylcarbonyl group, a selenophenylcarbonyl group, an optionally substituted amino group, or a nitro group, and more preferably an optionally halogen-substituted alkyl group, an alkylcarbonyl group, or a thienylcarbonyl group. In formula (a2) above, m1 may be selected depending on the type of ring Z¹, and may be, for example, an integer of 0 or more and 4 or less, preferably an integer of 0 or more and 3 or less, and more preferably an integer of 0 or more and 2 or less.

In formula (a3) above, R⁵ is preferably an alkylene group, a hydroxy group, an optionally substituted amino group, a nitro-substituted alkylene group, or a group represented by formula (a5) above, and more preferably a group represented by formula (a5) above. In formula (a3) above, R⁶ is preferably an alkyl group, a hydroxy group, an optionally substituted amino group, a nitro-substituted alkyl group, or a group represented by formula (a6) above, and more preferably a group represented by formula (a6) above. In formula (a3) above, A² is preferably S or O, and more preferably S. In formula (a3) above, n1 is preferably 0.

In formula (a4) above, R⁷ and R⁸ are preferably each independently an alkylene group, a hydroxy group, an optionally substituted amino group, or a nitro-substituted alkylene group, or a group represented by formula (a5) above, and more preferably a group represented by formula (a5) above. R⁷ and R⁸ may be the same or different. In formula (a4) above, each of R⁹ and R¹⁰ is preferably a group represented by formula (a2) above. R⁹ and R¹⁰ may be the same or different. In formula (a4) above, when R⁹ and R¹⁰ are bonded to each other to form a ring together with the sulfur atom in the formula, the ring is preferably a 3- to 10-membered ring including the sulfur atom, and more preferably a 5- to 7-membered ring. The ring may be polycyclic. Such a polycyclic ring is preferably a fused ring of two or more 5- to 7-membered rings. In formula (a4) above, A³ is preferably S or O, and more preferably S. In formula (a4) above, n2 is preferably 0.

In formula (a5) above, R¹¹ is preferably an optionally halogen-substituted alkyl group, a hydroxy group, an optionally substituted amino group, or a nitro group, and more preferably an optionally halogen-substituted alkyl group. In formula (a5) above, m2 may be selected depending on the type of ring Z², and may be, for example, an integer of 0 or more and 4 or less, preferably an integer of 0 or more and 3 or less, and more preferably an integer of 0 or more and 2 or less.

In formula (a6) above, R¹² is preferably an optionally halogen-substituted alkyl group, a hydroxy group, an alkylcarbonyl group, a thienylcarbonyl group, a furanylcarbonyl group, a selenophenylcarbonyl group, an optionally substituted amino group, or nitro group, and more preferably an optionally halogen-substituted alkyl group, an alkylcarbonyl group, or a thienylcarbonyl group. In formula (a6) above, m3 may be selected depending on the type of ring Z³, and may be, for example, an integer of 0 or more and 4 or less, preferably an integer of 0 or more and 3 or less, and more preferably an integer of 0 or more and 2 or less.

The counter anion for the cationic moiety represented by formula (a1) above is a monovalent anion corresponding to an acid generated when the sulfonium salt having the cationic moiety represented by formula (a1) is irradiated with actinic energy rays (e.g., visible rays, ultraviolet rays, electron beams, X-rays). The counter anion for the cationic moiety represented by formula (a1) preferably includes an anionic moiety represented by formula (aii) above or an anionic moiety represented by formula (aiii) above. The counter anion for the cationic moiety represented by formula (a1) is also preferably any other monovalent polyatomic anion, and more preferably an anion represented by MYₐ⁻, (Rf)_{b}PF_{6-b}⁻, R^{x1}_{c}BY_{4-c}⁻, R^{x1}_{c}GaY_{4-c}⁻, R^{x2}SO₃⁻, (R^{x2}SO₂)₃C⁻, or (R^{x2}SO₂)₂N⁻. The counter anion for the cationic moiety represented by formula (a1) may also be a halogen anion, such as a fluoride ion, a chloride ion, a bromide ion, or an iodide ion.

M represents a phosphorus atom, a boron atom, or an antimony atom. Y represents a halogen atom (preferably a fluorine atom).

Rf represents an alkyl group (preferably an alkyl group having 1 or more and 8 or less carbon atoms) with 80 mol % or more of hydrogen atoms replaced by fluorine atoms. Examples of the alkyl group to be fluorine-substituted for Rf include a linear alkyl group (e.g., methyl, ethyl, propyl, butyl, pentyl, octyl), a branched alkyl group (e.g., isopropyl, isobutyl, sec-butyl, tert-butyl), and a cycloalkyl group (e.g., cyclopropyl, cyclobutyl, cyclopentyl, cyclohexyl). The rate of replacement of hydrogen atoms with fluorine atoms in the alkyl group for Rf is preferably 80% by mole or more, more preferably 90% by mole or more, and even more preferably 100% by mole, based on the moles of hydrogen atoms possessed by the original alkyl group. When the rate of replacement with fluorine atoms falls within these ranges, the sulfonium salt (Q) can have higher photosensitivity. Particularly preferred examples of Rf include CF₃⁻, CF₃CF₂⁻, (CF₃)₂CF⁻, CF₃CF₂CF₂⁻, CF₃CF₂CF₂CF₂⁻, (CF₃)₂CFCF₂⁻, CF₃CF₂(CF₃)CF⁻, and (CF₃)₃C⁻.
The b Rf moieties are mutually independent and may be the same or different.

P represents a phosphorus atom, and F represents a fluorine atom.

R^{x1} represents a phenyl group with some hydrogen atoms replaced by at least one element or electron-withdrawing group. Examples of such an element include halogen atoms, such as fluorine, chlorine, and bromine. Examples of the electron-withdrawing group include a trifluoromethyl group, a nitro group, and a cyano group. Among them, a phenyl group with at least one hydrogen atom replaced by a fluorine atom or a trifluoromethyl group is preferred. The c R^{x1} moieties are mutually independent and may be the same or different.

B represents a boron atom, and Ga represents a gallium atom.

R^{x2} represents an alkyl group having 1 or more and 20 or less carbon atoms, a fluoroalkyl group having 1 or more and 20 or less carbon atoms, or an aryl group having 6 or more and 20 or less carbon atoms, in which the alkyl group and the fluoroalkyl group may be linear, branched, or cyclic, and the alkyl group, the fluoroalkyl group, or the aryl group may be unsubstituted or have a substituent. Examples of the substituent include a hydroxy group, optionally substituted amino groups (e.g., groups listed later in the description about formulas (a2) to (a6)), and a nitro group. The carbon chain in the alkyl group, the fluoroalkyl group, or the aryl group represented by R^{x2} may also have a hetero atom such as an oxygen atom, a nitrogen atom, or a sulfur atom. Specifically, the carbon chain in the alkyl or fluoroalkyl group represented by R^{x2} may also have a divalent functional group (e.g., ether bond, carbonyl bond, ester bond, amino bond, amide bond, imide bond, sulfonyl bond, sulfonylamide bond, sulfonylimide bond, urethane bond). The alkyl group, the fluoroalkyl group, or the aryl group represented by R^{x2} may have one or two or more substituents, hetero atoms, or functional groups mentioned above.

S represents a sulfur atom, O represents an oxygen atom, C represents a carbon atom, and N represents a nitrogen atom. The letter a represents an integer of 4 or more and 6 or less. The letter b is preferably an integer of 1 or more and 5 or less, more preferably an integer of 2 or more and 4 or less, and even more preferably 2 or 3. The letter c is preferably an integer of 1 or more and 4 or less, and more preferably 4.

The anion represented by MYₐ⁻ may be an anion represented by SbF₆⁻, PF₆⁻, or BF₄⁻.

The anion represented by (Rf)_{b}PF_{6-b}⁻ may be an anion represented by (CF₃CF₂)₂PF₄⁻, (CF₃CF₂)₃PF₃⁻, ((CF₃)₂CF)₂PF₄⁻, ((CF₃)₂CF)₃PF₃⁻, (CF₃CF₂CF₂)₂PF₄⁻, (CF₃CF₂CF₂)₃PF₃⁻, ((CF₃)₂CFCF₂)₂PF₄⁻, ((CF₃)₂CFCF₂)₃PF₃⁻, (CF₃CF₂CF₂CF₂)₂PF₄⁻, or (CF₃CF₂CF₂CF₂)₃PF₃⁻. Among them, an anion represented by (CF₃CF₂)₃PF₃⁻, (CF₃CF₂CF₂)₃PF₃⁻, ((CF₃)₂CF)₃PF₃⁻, ((CF₃)₂CF)₂PF₄⁻, ((CF₃)₂CFCF₂)₃PF₃⁻, or ((CF₃)₂CFCF₂)₂PF₄⁻ is preferred.

The anion represented by R^{x1}_{c}BY_{4-c}⁻ is preferably represented by the formula:

R^{x1}_{c}BY_{4-c}⁻

wherein R^{x1} represents a phenyl group with at least one hydrogen atom replaced by a halogen atom or an electron-withdrawing group, Y represents a halogen atom, and c represents an integer of 1 or more and 4 or less, which may be, for example,
an anion represented by (C₆F₅)₄B⁻, ((CF₃)₂C₆H₃)₄B⁻, (CF₃C₆H₄)₄B⁻, (C₆F₅)₂BF₂⁻, C₆F₅BF₃⁻, or (C₆H₃F₂)₄B⁻. Among them, an anion represented by (C₆F₅)₄B⁻ or ((CF₃)₂C₆H₃)₄B⁻ is preferred.

The anion represented by R^{x1}_{c}GaY_{4-c}⁻ may be an anion represented by (C₆F₅)₄Ga⁻, ((CF₃)₂C₆H₃)₄Ga⁻, (CF₃C₆H₄)₄Ga⁻, (C₆F₅)₂GaF₂⁻, C₆F₅GaF₃⁻, or (C₆H₃F₂)₄Ga⁻. Among them, an anion represented by (C₆F₅)₄Ga⁻ or ((CF₃)₂C₆H₃)₄Ga⁻ is preferred.

Examples of the anion represented by R^{x2}SO₃⁻ include trifluoromethanesulfonate anion, pentafluoroethanesulfonate anion, heptafluoropropanesulfonate anion, nonafluorobutanesulfonate anion, pentafluorophenylsulfonate anion, p-toluenesulfonate anion, benzenesulfonate anion, camphorsulfonate anion, methanesulfonate anion, ethanesulfonate anion, propanesulfonate anion, and butanesulfonate anion. Among them, trifluoromethanesulfonate anion, nonafluorobutanesulfonate anion, methanesulfonate anion, butanesulfonate anion, camphorsulfonate anion, benzenesulfonate anion, or p-toluenesulfonate anion is preferred.

The anion represented by (R^{x2}SO₂)₃C⁻ may be an anion represented by (CF₃SO₂)₃C⁻, (C₂F₅SO₂)₃C⁻, (C₃F₇SO₂)₃C⁻, or (C₄F₉SO₂)₃C⁻.

The anion represented by (R^{x2}SO₂)²N⁻ may be an anion represented by (CF₃SO₂)₂N⁻, (C₂F₅SO₂)₂N⁻, (C₃F₇SO₂)₂N⁻, or (C₄F₉SO₂)₂N⁻.

The monovalent polyatomic anion may be not only an anion represented by MYₐ⁻, (Rf)_{b}PF_{6-b}⁻, R^{x1}_{c}BY_{4-c}⁻, R^{x1}_{c}GaY_{4-c}⁻, R^{x2}SO₃⁻, (R^{x2}SO₂)₃C⁻, or (R^{x2}SO₂)₂N⁻, but also perhalogenate ion (e.g., ClO₄⁻, BrO₄⁻), halogenated sulfonate ion (e.g., FSO₃⁻, ClSO₃⁻), sulfate ion (e.g., CH₃SO₄⁻, CF₃SO₄⁻, HSO₄⁻), carbonate ion (e.g., HCO₃⁻, CH₃CO₃⁻), aluminate ion (e.g., AlCl₄⁻, AlF₄⁻), hexafluorobismuthate ion (BiF₆⁻), carboxylate ion (e.g., CH₃COO⁻, CF₃COO⁻, C₆H₅COO⁻, CH₃C₆H₄COO⁻, C₆F₅COO⁻, CF₃C₆H₄COO⁻), arylborate ion (e.g., B(C₆H₅)₄⁻, CH₃CH₂CH₂CH₂B(C₆H₅)₃⁻), thiocyanate ion (SCN⁻), or nitrate ion (NO₃⁻).

Among them, for cationic polymerization ability, anions represented by MYₐ⁻, (Rf)_{b}PF_{6-b}⁻, R^{x1}_{c}BY_{4-c}⁻, R^{x1}_{c}GaY_{4-c}⁻, and (R^{x2}SO₂)₃C⁻ are preferred, and SbF₆⁻, PF₆⁻, (CF₃CF₂)₃PF₃⁻, (C₆F₅)₄B⁻, ((CF₃)₂C₆H₃)₄B⁻, (C₆F₅)₄Ga⁻, ((CF₃)₂C₆H₃)₄Ga⁻, and (CF₃SO₂)₃C⁻ are more preferred, and R^{x1}_{c}BY_{4-c}⁻ is further more preferred.

In formulas (a2), (a5), and (a6) above, the aromatic hydrocarbon ring may be a benzene ring or a fused polycyclic aromatic hydrocarbon ring (e.g., a fused bicyclic, tricyclic, or tetracyclic hydrocarbon ring, such as a fused bicyclic C₈-C₂₀ hydrocarbon ring, preferably a fused bicyclic C₁₀-C₁₆ hydrocarbon ring (e.g., a naphthalene ring) or a fused tricyclic aromatic hydrocarbon ring (e.g., an anthracene ring, a phenanthrene ring)). The aromatic hydrocarbon ring is preferably a benzene ring or a naphthalene ring, and more preferably a benzene ring.

In formulas (a1) to (a6) above, the halogen atom may be fluorine, chlorine, bromine, or iodine.

In formulas (a1) to (a6) above, the alkyl group may be a linear alkyl group having 1 or more and 18 or less carbon atoms (e.g., methyl, ethyl, n-propyl, n-butyl, n-pentyl, n-octyl, n-decyl, n-dodecyl, n-tetradecyl, n-hexadecyl, n-octadecyl), a branched alkyl group having 3 or more and 18 or less carbon atoms (e.g., isopropyl, isobutyl, sec-butyl, tert-butyl, isopentyl, neopentyl, tert-pentyl, isohexyl, isooctadecyl), or a cycloalkyl group having 3 or more and 18 or less carbon atoms (e.g., cyclopropyl, cyclobutyl, cyclopentyl, cyclohexyl, 4-decylcyclohexyl). Specifically, in formulas (a1), (a2), and (a4) to (a6) above, the term “optionally halogen-substituted alkyl group” is intended to include an alkyl group and an alkyl group substituted with a halogen atom. The halogen-substituted alkyl group may be a group derived from the linear alkyl group, the branched alkyl group, or the cycloalkyl group by replacing at least one hydrogen atom by a halogen atom (e.g., monofluoromethyl, difluoromethyl, trifluoromethyl). In particular, the optionally halogen-substituted alkyl group for R¹, R², R⁹, or R¹⁰ is preferably a trifluoromethyl group, and R⁴, R⁶, R¹¹, or R¹² is preferably a methyl group.

In formulas (a2) to (a6) above, the alkoxy group may be a linear or branched alkoxy group having 1 or more and 18 or less carbon atoms (e.g., methoxy, ethoxy, propoxy, isopropoxy, butoxy, isobutoxy, sec-butoxy, tert-butoxy, hexyloxy, decyloxy, dodecyloxy, octadecyloxy).

In formulas (a2) to (a6) above, the alkyl group in the alkylcarbonyl group may be a linear alkyl group having 1 to 18 carbon atoms, a branched alkyl group having 3 or more and 18 or less carbon atoms, or a cycloalkyl group having 3 or more and 18 or less carbon atoms as mentioned above, and the alkylcarbonyl group may be a linear, branched, or cyclic alkylcarbonyl group having 2 or more and 18 or less carbon atoms (e.g., acetyl, propionyl, butanoyl, 2-methylpropionyl, heptanoyl, 2-methylbutanoyl, 3-methylbutanoyl, octanoyl, decanoyl, dodecanoyl, octadecanoyl, cyclopentanoyl, cyclohexanoyl).

In formulas (a3) to (a6) above, the arylcarbonyl group may be an arylcarbonyl group having 7 or more and 11 or less carbon atoms (e.g., benzoyl, naphthoyl).

In formulas (a2) to (a6) above, the alkoxycarbonyl group may be a linear or branched alkoxycarbonyl group having 2 or more and 19 or less carbon atoms (e.g., methoxycarbonyl, ethoxycarbonyl, propoxycarbonyl, isopropoxycarbonyl, butoxycarbonyl, isobutoxycarbonyl, sec-butoxycarbonyl, tert-butoxycarbonyl, octyloxycarbonyl, tetradecyloxycarbonyl, octadecyloxycarbonyl).

In formulas (a3) to (a6) above, the aryloxycarbonyl group may be an aryloxycarbonyl group having 7 or more and 11 or less carbon atoms (e.g., phenoxycarbonyl, naphthoxycarbonyl).

In formulas (a3) to (a6) above, the arylthiocarbonyl group may be an arylthiocarbonyl group having 7 or more and 11 or less carbon atoms (e.g., phenylthiocarbonyl, naphthoxythiocarbonyl).

In formulas (a2) to (a6) above, the acyloxy group may be a linear or branched acyloxy group having 2 or more and 19 or less carbon atoms (e.g., acetoxy, ethylcarbonyloxy, propylcarbonyloxy, isopropylcarbonyloxy, butylcarbonyloxy, isobutylcarbonyloxy, sec-butylcarbonyloxy, tert-butylcarbonyloxy, octylcarbonyloxy, tetradecylcarbonyloxy, octadecylcarbonyloxy).

In formula (a3) to (a6) above, the arylthio group may be an arylthio group having 6 or more and 20 or less carbon atoms (e.g., phenylthio, 2-methylphenylthio, 3-methylphenylthio, 4-methylphenylthio, 2-chlorophenylthio, 3-chlorophenylthio, 4-chlorophenylthio, 2-bromophenylthio, 3-bromophenylthio, 4-bromophenylthio, 2-f luorophenylthio, 3-f luorophenylthio, 4-fluorophenylthio, 2-hydroxyphenylthio, 4-hydroxyphenylthio, 2-methoxyphenylthio, 4-methoxyphenylthio, 1-naphthylthio, 2-naphthylthio, 4-[4-(phenylthio)benzoyl]phenylthio, 4-[4-(phenylthio)phenoxy]phenylthio, 4-[4-(phenylthio)phenyl]phenylthio, 4-(phenylthio)phenylthio, 4-benzoylphenylthio, 4-benzoyl-2-chlorophenylthio, 4-benzoyl-3-chlorophenylthio, 4-benzoyl-3-methylthiophenylthio, 4-benzoyl-2-methylthiophenylthio, 4-(4-methylthiobenzoyl)phenylthio, 4-(2-methylthiobenzoyl)phenylthio, 4-(p-methylbenzoyl)phenylthio, 4-(p-ethylbenzoyl)phenylthiol, 4-(p-isopropylbenzoyl)phenylthio, 4-(p-tert-butylbenzoyl)phenylthio).

In formulas (a2) to (a6) above, the alkylthio group may be a linear or branched alkylthio group having 1 or more and 18 or less carbon atoms (e.g., methylthio, ethylthio, propylthio, isopropylthio, butylthio, isobutylthio, sec-butylthio, tert-butylthio, pentylthio, isopentylthio, neopentylthio, tert-pentylthio, octylthio, decylthio, dodecylthio, isooctadecylthio).

In formulas (a3) to (a6) above, the aryl group may be an aryl group having 6 or more and 10 or less carbon atoms (e.g., phenyl, tolyl, dimethylphenyl, naphthyl).

In formula (a2), the heterocyclic aliphatic hydrocarbon group may be a heterocyclic hydrocarbon group having 2 or more and 20 or less carbon atoms (preferably 4 or more and 20 or less carbon atoms) (e.g., pyrrolidinyl, tetrahydro furanyl, tetrahydrothienyl, piperidinyl, tetrahydro pyranyl, tetrahydrothiopyranyl, morpholinyl).

In formula (a3) to (a6) above, the heterocyclic hydrocarbon group may be a heterocyclic hydrocarbon group having 4 or more and 20 or less carbon atoms (e.g., thienyl, furanyl selenophenyl, pyranyl, pyrrolyl, oxazolyl, thiazolyl, pyridyl, pyrimidyl, pyrazinyl, indolyl, benzofuranyl, benzothienyl, quinolyl, isoquinolyl, quinoxalinyl, quinazolinyl, carbazolyl, acridinyl, phenothiazinyl, phenazinyl, xanthenyl, thiantherenyl, phenoxazinyl, phenoxathiynyl, chromanyl, isochromanyl, dibenzothienyl, xanthonyl, thioxanthonyl, dibenzofuranyl).

In formulas (a3) to (a6) above, the aryloxy group may be an aryloxy group having 6 or more and 10 or less carbon atoms (e.g., phenoxy, naphthyloxy).

In the formulas (a2) to (a6) above, the alkylsulfinyl group may be a linear or branched sulfinyl group having 1 or more and 18 or less carbon atoms (e.g., methylsulfinyl, ethylsulfinyl, propylsulfinyl, isopropylsulfinyl, butylsulfinyl, isobutylsulfinyl, sec-butylsulfinyl, tert-butylsulfinyl, pentylsulfinyl, isopentylsulfinyl, neopentylsulfinyl, tert-pentylsulfinyl, octylsulfinyl, isooctadecylsulfinyl).

In formulas (a3) to (a6) above, the arylsulfinyl group may be an arylsulfinyl group having 6 or more and 10 or less carbon atoms (e.g., phenylsulfinyl, tolylsulfinyl, naphthylsulfinyl).

In formulas (a2) to (a6) above, the alkylsulfonyl group may be a linear or branched alkylsulfonyl group having 1 or more and 18 or less carbon atoms (e.g., methylsulfonyl, ethylsulfonyl, propylsulfonyl, isopropylsulfonyl, butylsulfonyl, isobutylsulfonyl, sec-butylsulfonyl, tert-butylsulfonyl, pentylsulfonyl, isopentylsulfonyl, neopentylsulfonyl, tert-pentylsulfonyl, octylsulfonyl, octadecylsulfonyl).

In formulas (a3) to (a6) above, the arylsulfonyl group may be an arylsulfonyl group having 6 or more and 10 or less carbon atoms (e.g., phenylsulfonyl, tolylsulfonyl (tosyl group), naphthylsulfonyl).

In formulas (a2) to (a6) above, the hydroxy(poly)alkyleneoxy group may be a hydroxy(poly)alkyleneoxy group represented by HO(AO)_{q}—, wherein each AO independently represents an ethyleneoxy group and/or a propyleneoxy group, and q represents an integer of 1 or more and 5 or less.

In formulas (a2) to (a6) above, the optionally substituted amino group may be an amino group (—NH₂) or a substituted amino group having 1 or more and 15 or less carbon atoms (e.g., methylamino, dimethylamino, ethylamino, methylethylamino, diethylamino, n-propylamino, methyl-n-propylamino, ethyl-n-propylamino, n-propylamino, isopropylamino, isopropylmethylamino, isopropylethylamino, diisopropylamino, phenylamino, diphenylamino, methylphenylamino, ethylphenylamino, n-propylphenylamino, isopropylphenylamino).

In formulas (a3) and (a4) above, the alkylene group may be a linear or branched alkylene group having 1 or more and 18 or less carbon atoms (e.g., methylene group, 1,2-ethylene group, 1,1-ethylene group, propane-1,3-diyl group, propane-1,2-diyl group, propane-1,1-diyl group, propane-2,2-diyl group, butane-1,4-diyl group, butane-1,3-diyl group, butane-1,2-diyl group, butane-1,1-diyl group, butane-2,2-diyl group, butane-2,3-diyl group, pentane-1,5-diyl group, pentane-1,4-diyl group, hexane-1,6-diyl group, heptane-1,7-diyl group, octane-1,8-diyl group, 2-ethylhexane-1,6-diyl group, nonane-1,9-diyl group, decane-1,10-diyl group, undecane-1,11-diyl group, dodecane-1,12-diyl group, tridecane-1,13-diyl group, tetradecane-1,14-diyl group, pentadecane-1,15-diyl group, hexadecane-1,16-diyl group).

The sulfonium salt having a cationic moiety represented by formula (a1) can be synthesized, for example, according to the following scheme. Specifically, 1-fluoro-2-methyl-4-nitrobenzene represented by formula (b1) below is reacted with a compound represented by formula (b2) below in the presence of a base such as potassium hydroxide to give a nitro compound represented by formula (b3) below, which is then reduced in the presence of reduced iron to give an amine compound represented by formula (b4) below. The amine compound is reacted with a nitrite (e.g., sodium nitrite) represented by MaNO₂, wherein Ma represents a metal atom, such as an alkali metal atom (e.g., sodium atom), to give a diazo compound. The diazo compound is then mixed with a cuprous halide represented by CuX′, wherein X′ represents a halogen atom, such as bromine (the same applies hereinafter), and a hydrogen halide represented by HX′, and the mixture is allowed to undergo reaction to give a halide represented by formula (b5) below. The resulting halide is used together with magnesium to form a Grignard reagent. In the presence of chlorotrimethylsilane, the Grignard reagent is reacted with a sulfoxide compound represented by formula (b6) below to give a sulfonium salt represented by formula (b7) below. The sulfonium salt is further reacted with a salt represented by Mb⁺X″⁻, wherein Mb⁺ represents a metal cation such as an alkali metal cation (e.g., potassium ion), and X″⁻ represents a monovalent anion represented by X⁻, exclusive of halogen anion, for salt exchange reaction to give a sulfonium salt represented by formula (b8) below. In formulas (b2) to (b8) below, R¹ to R³ and A¹ are the same as defined for formula (a1) above.

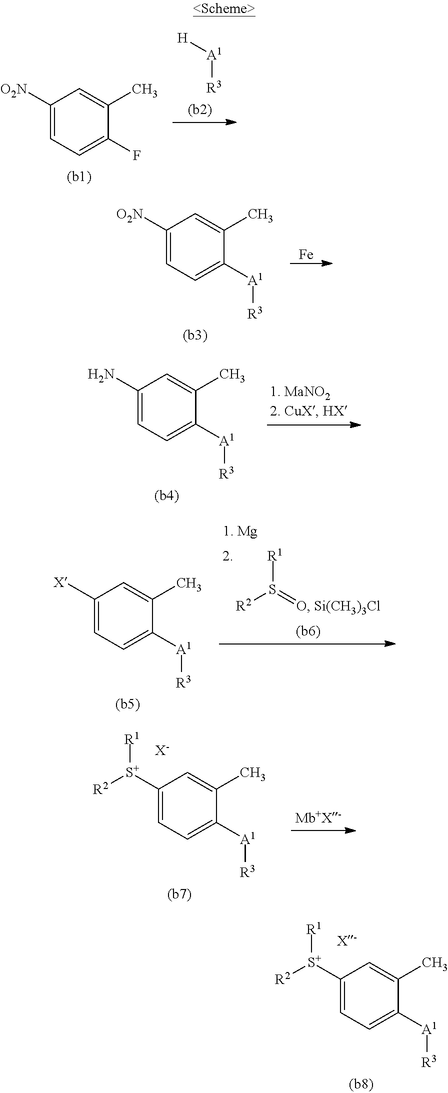

Examples of the cationic moiety represented by formula (a1) above include the cations shown below. Examples of the anionic moiety for the cationic moiety represented by formula (a1) above include anions known in the art, such as those listed above. The sulfonium salt having a cationic moiety represented by formula (a1) above can be synthesized according to the above scheme, in which X⁻ represents a counter anion, and may be subjected to salt exchange reaction, if necessary, so that the cationic moiety can be combined with a desired anionic moiety. Specifically, the cationic moiety is preferably combined with an anionic moiety represented by formula (aii) above or an anionic moiety represented by formula (aiii) above.

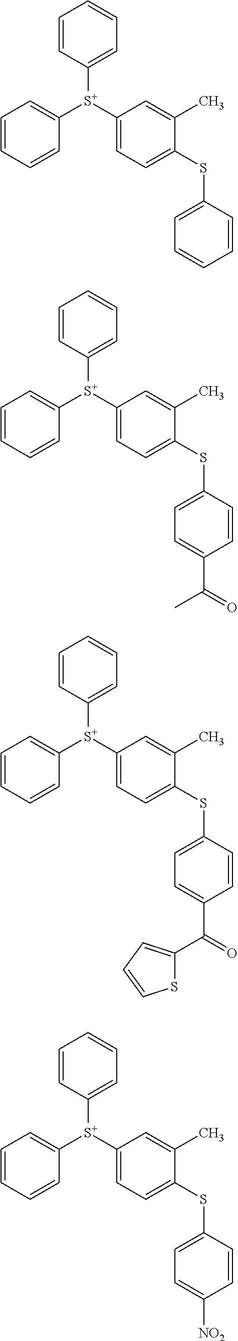 [SMILES: Cc1cc([S+](c2ccccc2)c2ccccc2)ccc1Sc1ccccc1 ; CC(=O)c1ccc(Sc2ccc([S+](c3ccccc3)c3ccccc3)cc2C)cc1 ; Cc1cc([S+](c2ccccc2)c2ccccc2)ccc1Sc1ccc(C(=O)c2cccs2)cc1 ; Cc1cc([S+](c2ccccc2)c2ccccc2)ccc1Sc1ccc([N+](=O)[O-])cc1]

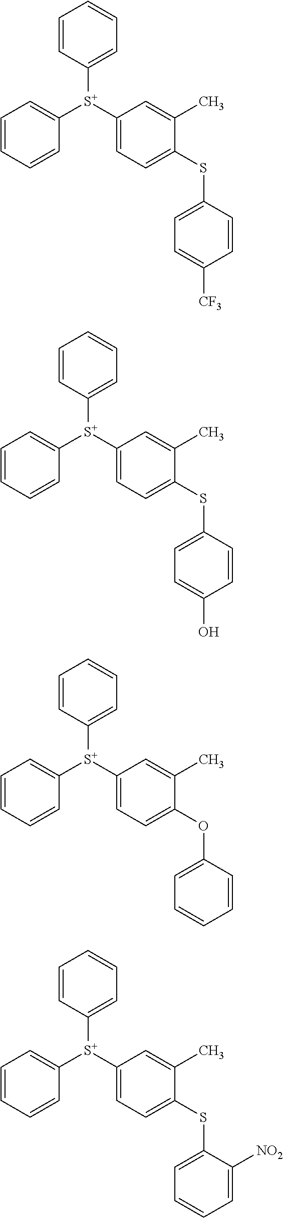 [SMILES: Cc1cc([S+](c2ccccc2)c2ccccc2)ccc1Sc1ccc(C(F)(F)F)cc1 ; Cc1cc([S+](c2ccccc2)c2ccccc2)ccc1Sc1ccc(O)cc1 ; Cc1cc([S+](c2ccccc2)c2ccccc2)ccc1Oc1ccccc1 ; Cc1cc([S+](c2ccccc2)c2ccccc2)ccc1Sc1ccccc1[N+](=O)[O-]]

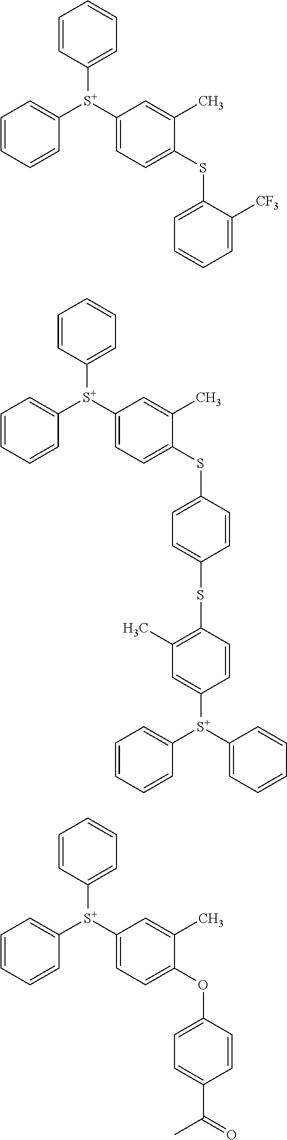 [SMILES: Cc1cc([S+](c2ccccc2)c2ccccc2)ccc1Sc1ccccc1C(F)(F)F ; Cc1cc([S+](c2ccccc2)c2ccccc2)ccc1Sc1ccc(Sc2ccc([S+](c3ccccc3)c3ccccc3)cc2C)cc1 ; CC(=O)c1ccc(Oc2ccc([S+](c3ccccc3)c3ccccc3)cc2C)cc1]

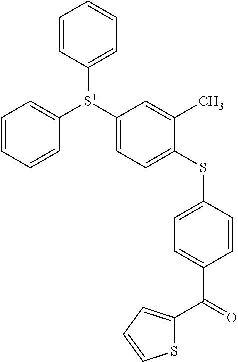 [SMILES: Cc1cc([S+](c2ccccc2)c2ccccc2)ccc1Sc1ccc(C(=O)c2cccs2)cc1]

Among the group of preferred cationic moieties shown above, the cationic moiety represented by the following formula is more preferred.

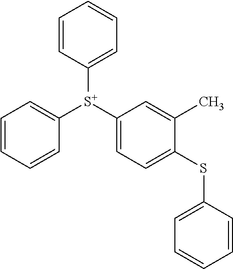 [SMILES: Cc1cc([S+](c2ccccc2)c2ccccc2)ccc1Sc1ccccc1]

### [Thermal Acid Generator (A2)]

The thermal acid generator (A2) may be any conventional thermal acid generator known in the art. The thermal acid generator (A2) is preferably, for example, an onium salt having an anionic moiety represented by formula (Ai) below.

(R^{A1})₄—Ga⁻ (Ai)

In formula (Ai), each R^{A1} is independently a phenyl group optionally having one or more substituents, or a perfluoroalkyl group.

In formula (Ai), the four R^{A1} moieties are each a phenyl group optionally having one or more substituents, or a perfluoroalkyl group. The phenyl group for R^{A1} may have any substituent as long as the object of the present invention is not impaired. Preferred examples of such a substituent include a perfluoroalkyl group, a perfluoroalkoxy group, a nitro group, a cyano group, an acyl group, and a halogen atom. The phenyl group for R^{A1} may have a plurality of substituents, which may be the same or different.

The perfluoroalkyl group as a substituent on the phenyl group preferably has 1 or more and 8 or less carbon atoms, and more preferably 1 or more and 4 or less carbon atoms. Examples of the perfluoroalkyl group as a substituent on the phenyl group include linear perfluoroalkyl groups such as a trifluoromethyl group, a pentafluoroethyl group, a heptafluoropropyl group, a nonafluorobutyl group, a perfluoropentyl group, and a perfluorooctyl group; branched perfluoroalkyl groups such as a heptafluoroisopropyl group, a nonafluoroisobutyl group, a nonafluoro-sec-butyl group, and a nonafluoro-tert-butyl group; and fluorocycloalkyl groups such as a perfluorocyclopropyl group, a perfluorocyclobutyl group, a perfluorocyclopentyl group, and a perfluorocyclohexyl group.

The perfluoroalkoxy group as a substituent on the phenyl group preferably has 1 or more and 8 or less carbon atoms, and more preferably 1 or more and 4 or less carbon atoms. Examples of the perfluoroalkoxy group as a substituent on the phenyl group include linear perfluoroalkoxy groups such as a trifluoromethoxy group, a pentafluoroethoxy group, a heptafluoropropyloxy group, a nonafluorobutyloxy group, a perfluoropentyloxy group, and a perfluorooctyloxy group; and branched perfluoroalkoxy groups such as a heptafluoroisopropyloxy group, a nonafluoroisobutyloxy group, a nonafluoro-sec-butyloxy group, and a nonafluoro-tert-butyloxy group.

Examples of the halogen atom as a substituent on the phenyl group include fluorine, chlorine, bromine, and iodine.

Preferred examples of the perfluoroalkyl group for R^{A1} include those of the perfluoroalkyl group as a substituent on the phenyl group.

For the cationic polymerization ability of the thermal acid generator (A2), at least one of the R^{A1} moieties is preferably a phenyl group substituted with one or more selected from the group consisting of a perfluoroalkyl group and a fluorine atom, and more preferably, all of the R^{A1} moieties are phenyl groups substituted with one or more groups selected from the group consisting of a perfluoroalkyl group and a fluorine atom.

Preferred examples of R^{A1} include a pentafluorophenyl group, a trifluorophenyl group, a tetrafluorophenyl group, a (trifluoromethyl)phenyl group, a bis(trifluoroethyl)phenyl group, a (pentafluoroethyl)phenyl group, a bis(pentafluoroethyl)phenyl group, a fluoro(trifluoromethyl)phenyl group, a fluorobis(trifluoromethyl)phenyl group, a fluoro(pentafluoroethyl)phenyl group, a fluorobis (pentafluoroethyl)phenyl group, a pentachlorophenyl group, a trichlorophenyl group, a tetrachlorophenyl group, a (trichloromethyl)phenyl group, a bis(trichloromethyl)phenyl group, a (pentachloroethyl)phenyl group, a bis(pentachloroethyl)phenyl group, a chloro(trichloromethyl)phenyl group, a chlorobis(trichloromethyl)phenyl group, a chloro(pentachloroethyl)phenyl group, a chlorobis(pentachloroethyl)phenyl group, a nitrophenyl group, a cyanophenyl group, and an acetylphenyl group. Among them, a pentafluorophenyl group and a bis(trifluoromethyl)phenyl group are preferred, and a pentafluorophenyl group is more preferred.

Preferred examples of the anionic moiety represented by formula (Ai) include the following anions.

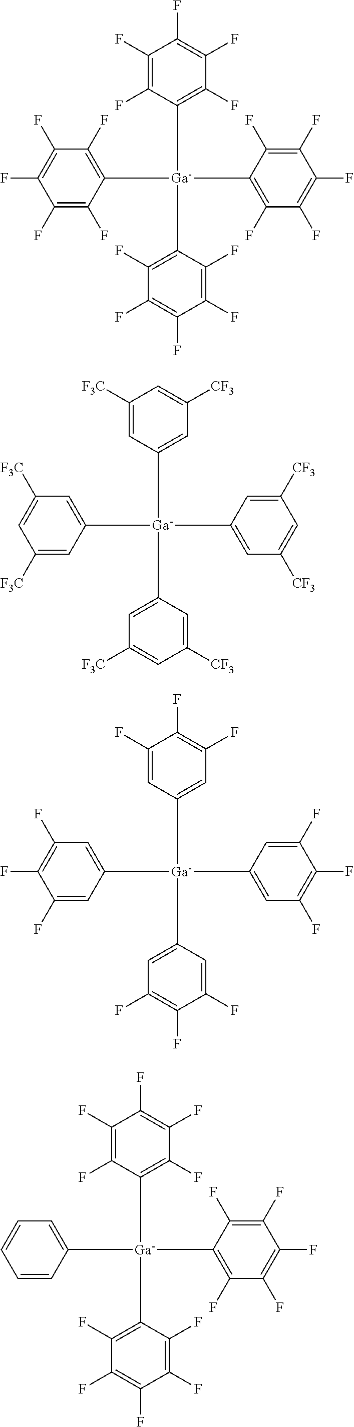

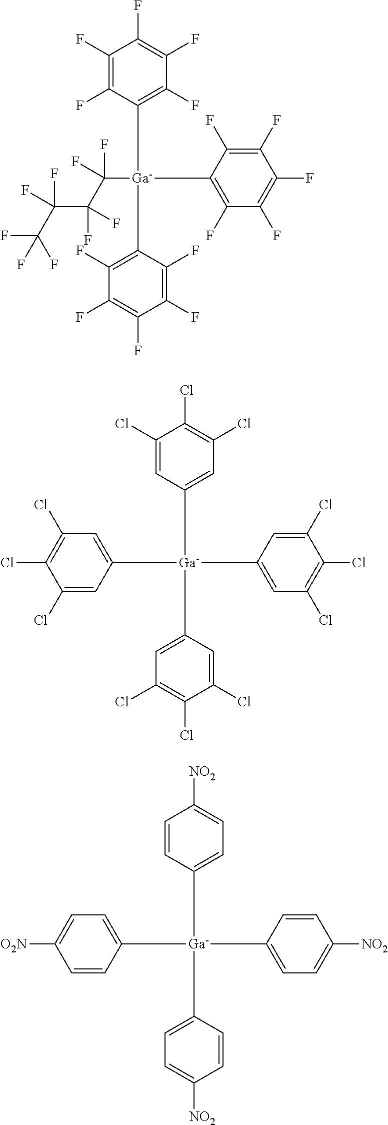

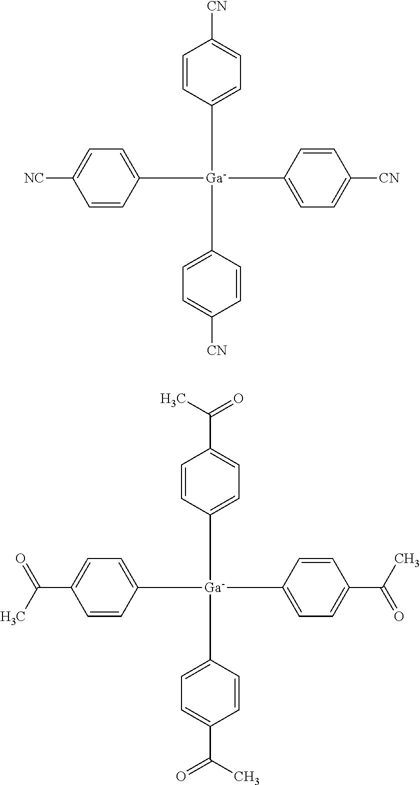

The anionic moiety represented by formula (Ai) above forms an onium salt as the thermal acid generator (A2) together with a cationic moiety, which is preferably represented by formula (Aii) below.

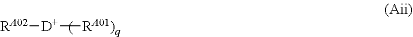

In formula (Aii), R^{A01} is a monovalent organic group, D is an element with a valence of q belonging to Groups 15 to 17 of the IUPAC Periodic Table of the Elements, and R^{A02} is an optionally substituted alkyl group or an optionally substituted aralkyl group. When R^{A02} is an optionally substituted alkyl group, at least one R^{A01} is an optionally substituted alkyl group. The letter q is an integer of 1 or more and 3 or less, and a plurality of R^{A01} may be the same or different, and a plurality of R^{A01} may be bonded to form a ring together with D.

In formula (Aii), D is an element with a valence of q belonging to Groups 15 to 17 of the IUPAC Periodic Table of the Elements. D is the same as defined for R^{a02} in formula (ai) above. D is bonded to the organic group R^{A01} and the optionally substituted benzyl group for R^{A02} to form an onium ion. The element belonging to Groups 15 to 17 of the IUPAC Periodic Table of the Elements is preferably sulfur (S), nitrogen (N), iodine (I), or phosphorus (P). The corresponding onium ion is preferably sulfonium ion, ammonium ion, iodonium ion, or phosphonium ion because they are stable and easy to handle. Sulfonium ion and iodonium ion are more preferred, and sulfonium ion is even more preferred, because of their high cationic polymerization ability and high crosslinking reactivity.

In formula (Aii), R^{A01} represents an organic group bonded to D, and a plurality of R^{A01}, if any, may be the same or different. Examples of R^{A01} include an aromatic hydrocarbon group having 6 or more and 14 or less carbon atoms, an alkyl group having 1 or more and 18 or less carbon atoms, an alkenyl group having 2 or more and 18 or less carbon atoms, and an alkynyl group having 2 or more and 18 or less carbon atoms. Examples of the aromatic hydrocarbon group, the alkyl group, the alkenyl group, and the alkynyl group for R^{A01} include those listed above for R^{a01} in formula (ai). The aromatic hydrocarbon group for R^{A01} may have a substituent, examples of which include a hydroxyl group, an alkoxy group, an alkylcarbonyl group, an arylcarbonyl group, an alkoxycarbonyl group, an aryloxycarbonyl group, an arylthiocarbonyl group, an acyloxy group, an arylthio group, an alkylthio group, an aryl group, a heterocyclic hydrocarbon group, an aryloxy group, an alkylsulfinyl group, an arylsulfinyl group, an alkylsulfonyl group, an arylsulfonyl group, a hydroxy(poly)alkyleneoxy group, an optionally substituted silyl group, an optionally substituted amino group, and a halogen atom. In formula (Aii), a plurality of R^{A01}, if any, may form a ring together with D. The ring formed by the plurality of R^{A01} and D may have one or more intervening bonds selected from the group consisting of —O—, —S—, —SO—, —SO₂—, —NH—, —CO—, —COO—, and —CONH—. In formula (Aii), examples of the alkyl group for R^{A02} include linear alkyl groups having 1 or more and 18 or less carbon atoms, such as a methyl group, an ethyl group, an n-propyl group, an n-butyl group, an n-pentyl group, an n-octyl group, an n-decyl group, an n-dodecyl group, an n-tetradecyl group, an n-hexadecyl group, and an n-octadecyl group; branched alkyl groups having 3 or more and 18 or less carbon atoms, such as an isopropyl group, an isobutyl group, a sec-butyl group, a tert-butyl group, an isopentyl group, a neopentyl group, a tert-pentyl group, an isohexyl group, and an isooctadecyl group; and cycloalkyl groups having 3 or more and 18 or less carbon atoms, such as a cyclopropyl group, a cyclobutyl group, a cyclopentyl group, a cyclohexyl group, and a 4-decylcyclohexyl group. In formula (Aii), when R^{A02} is an optionally substituted alkyl group, at least one of R^{A01} is an optionally substituted alkyl group. In formula (Aii), examples of the aralkyl group for R^{A02} include lower alkyl groups substituted with an aryl group having 6 or more and 10 or less carbon atoms, such as a benzyl group, a 1-naphthylmethyl group, or a 2-naphthylmethyl group. In formula (Aii), examples of the substituted aralkyl group for R^{A02} include lower alkyl groups substituted with an optionally substituted aryl group having 6 or more and 10 or less carbon atoms, such as a 2-methylbenzyl group. In formula (Aii), R^{A02} is preferably an optionally substituted aralkyl group, and a cationic moiety represented by formula (Aiii) below is more preferred.

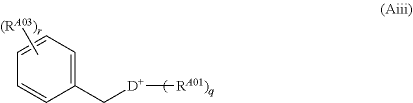

In formula (Aiii), R^{A01} is a monovalent organic group, D is an element with a valence of q belonging to Groups 15 to 17 of the IUPAC Periodic Table of the Elements, and R^{A03} is a monovalent organic group, q is an integer of 1 or more and 3 or less, and r is an integer of 0 or more and 5 or less.

In formula (Aiii), the monovalent organic group for R^{A03} is preferably an alkyl group, examples of which include those listed above for R^{A02} in formula (Aii). The letter r is preferably 0 or 1. As mentioned for formula (Aii), D is preferably sulfur, and the cation represented by formula (Aiii) is preferably a sulfonium ion. In other words, D is preferably sulfur, and q is preferably 2. Examples of the cationic moiety represented by formula (Aii) or (Aiii) are shown below. In the following examples, D′ is a S atom or a Se atom, and preferably a S atom.

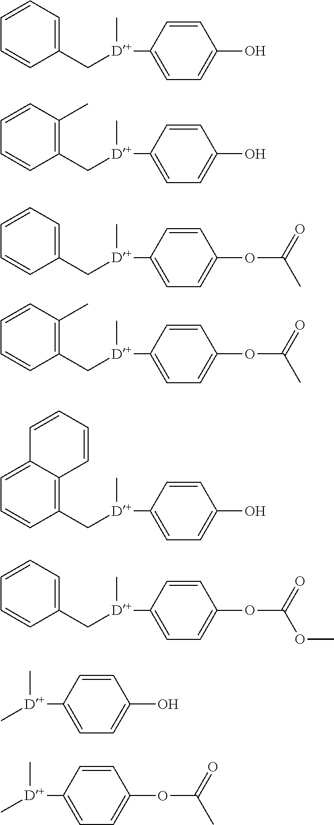

### [Curing Catalyst]

A curing catalyst may be used to enhance the curing properties of the group in formula (a-1) capable of undergoing hydrolysis to produce a silanol group. Such a curing catalyst may be one or more selected from the group consisting of a nitrogen-containing salt, a phosphine compound, a phosphonium salt, and a sulfonium salt. The nitrogen-containing salt may be a salt compound composed of a quaternary nitrogen-containing cation and a counter anion.

Examples of the nitrogen-containing salt include nitrogen-containing salts represented by formulas (D-1), (D-2), (D-3), (D-4), (D-5), and (D-6) below.

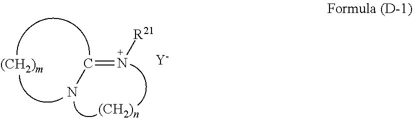

In formula (D-1), m is an integer of 2 or more and 11 or less, n is an integer of 2 or more and 3 or less, R²¹ is a hydrocarbon group, and Y⁻ is an anion.

R²²R²³R²⁴R²⁵N⁺ Y⁻ Formula (D-2)

In formula (D-2), R²², R²³, R²⁴, and R²⁵ are each independently a hydrocarbon group, Y⁻ is an anion, and R²², R²³, R²⁴, and R²⁵ are each bonded to the nitrogen atom through a C—N bond.

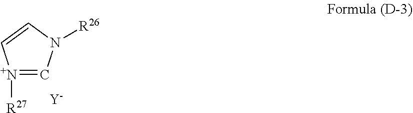

In formula (D-3), R²⁶ and R²⁷ are each independently a hydrocarbon group, and Y⁻ is an anion.

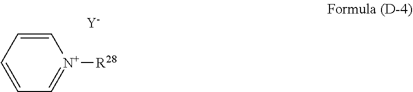

In formula (D-4), R²⁸ is a hydrocarbon group, and Y⁻ is an anion.

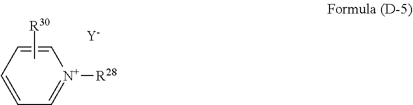

In formula (D-5), R²⁹ and R³⁰ are each independently a hydrocarbon group, and Y⁻ is an anion.

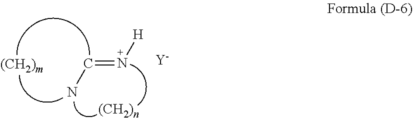

In formula (D-6), m is an integer of 2 or more and 11 or less, n is an integer of 2 or more and 3 or less, H is a hydrogen atom, and Y⁻ is an anion.

The phosphonium salt may be a quaternary phosphonium salt represented by formula (D-7).

R³¹R³²R³³R³⁴P⁺ Y⁻ Formula (D-7)

In formula (D-7), R³¹, R³², R³³, and R³⁴ are each independently a hydrocarbon group, Y⁻ is an anion, and R³¹, R³², R³³, and R³⁴ are each bonded to the phosphorus atom through a C—P bond.

The sulfonium salt may be a tertiary sulfonium salt represented by formula (D-8).

R³⁵R³⁶R³⁷S⁺ Y⁻ Formula (D-8)

In formula (D-8), R³⁵, R³⁶, and R³⁷ are each independently a hydrocarbon group, Y⁻ is an anion, and R³⁵, R³⁶, and R³⁷ are each bonded to the sulfur atom through a C—S bond.

In formula (D-1) above, the hydrocarbon group for R²¹ preferably has 1 or more and 18 or less carbon atoms, and more preferably 2 or more and 10 or less carbon atoms. Examples of the hydrocarbon group for R²¹ include an alkyl group, an alkenyl group, an alicyclic hydrocarbon group, a cycloalkylalkyl group, an aryl group, and an aralkyl group. Examples of the alkyl group include linear alkyl groups such as an ethyl group, an n-propyl group, and an n-butyl group. Examples of the alkenyl group include a vinyl group and an allyl group. Examples of the aralkyl group include a benzyl group and a phenethyl group. The alicyclic hydrocarbon group may have one or more unsaturated bonds. Examples of the alicyclic hydrocarbon group include a cyclopentyl group, a cyclohexyl group, a cycloheptyl group, and a dicyclopentadienyl group. The cycloalkylalkyl group may be, for example, a cyclohexylmethyl group. In formula (D-1), the anion (Y⁻) may be any type as long as the object of the present invention is not impaired. Preferred examples of the anion include halide ions such as chloride ion (Cl⁻), bromide ion (Br⁻), and iodide ion (I⁻), and organic anions having an anionic group such as —COO⁻, —SO₃—, or —O⁻.

In formula (D-2) above, R²², R²³, R²⁴, and R²⁵ are each preferably the same hydrocarbon group as R²¹ in formula (D-1). Examples of the anion (Y⁻) include halide ions such as chloride ion (Cl⁻), bromide ion (Br⁻), and iodide ion (I⁻), and organic anions having an anionic group such as —COO⁻, —SO₃⁻, or —O⁻. The quaternary ammonium salt represented by formula (D-2) is commercially available. Examples of such a quaternary ammonium salt include tetramethylammonium acetate, tetrabutylammonium acetate, triethylbenzylammonium chloride, triethylbenzylammonium bromide, trioctylmethylammonium chloride, tributylbenzylammonium chloride, and trimethylbenzylammonium chloride.

The nitrogen-containing salt represented by formula (D-3) above may be derived from a 1-substituted imidazole. R²⁶ and R²⁷ are each preferably the same hydrocarbon group as R²¹ in formula (D-1). The sum of the numbers of carbon atoms in R²⁶ and R²⁷ is preferably 7 or more. For example, R²⁶ is preferably a methyl group, an ethyl group, a propyl group, a phenyl group, or a benzyl group. R²⁷ is preferably a benzyl group, an octyl group, or an octadecyl group. Examples of the anion (Y⁻) include halide ions such as chloride ion (Cl⁻), bromide ion (Br⁻), and iodide ion (I⁻), and organic anions having an anionic group such as —COO⁻, —SO₃⁻, or —O⁻. The nitrogen-containing salt represented by formula (D-3) is commercially available. Such a nitrogen-containing salt can be produced by reacting an imidazole compound such as 1-methylimidazole or 1-benzylimidazole with an alkyl halide such as benzyl bromide or methyl bromide, or an aryl halide.

The nitrogen-containing salt represented by formula (D-4) above can be derived from pyridine. R²⁸ is preferably the same hydrocarbon group as R²¹ in formula (D-1). R²⁸ is preferably a lauryl group. Examples of the anion (Y⁻) include halide ions such as chloride ion (Cl⁻), bromide ion (Br⁻), and iodide ion (I⁻), and organic anions having an anionic group such as —COO⁻, —SO₃⁻, or —O⁻. The nitrogen-containing salt represented by formula (D-4) is commercially available. Such a nitrogen-containing salt can be produced, for example, by reacting pyridine with an alkyl halide such as lauryl chloride, benzyl chloride, benzyl bromide, methyl bromide, or octyl bromide, or an aryl halide. Examples of the nitrogen-containing salt represented by formula (D-4) include N-laurylpyridinium chloride and N-benzylpyridinium bromide.

The nitrogen-containing salt represented by formula (D-5) can be derived from a substituted pyridine such as picoline. R²⁹ is preferably the same hydrocarbon group as R²¹ in formula (D-1). The hydrocarbon group for R²⁹ preferably has 1 or more and 18 or less carbon atoms, and more preferably 4 or more and 18 or less carbon atoms. Preferred examples of the hydrocarbon group for R²⁹ include a methyl group, an octyl group, a lauryl group, and a benzyl group. R³⁰ is preferably the same hydrocarbon group as R²¹ in formula (D-1). When the nitrogen-containing salt represented by formula (D-5) is derived from, for example, picoline, R³⁰ is a methyl group. Examples of the anion (Y⁻) include halide ions such as chloride ion (Cl⁻), bromide ion (Br⁻), and iodide ion (I⁻), and organic anions having an anionic group such as —COO⁻, —SO₃⁻, or —O⁻. The nitrogen-containing salt represented by formula (D-5) is commercially available. The nitrogen-containing salt represented by formula (D-5) can be produced, for example, by reacting a substituted pyridine such as picoline with an alkyl halide such as methyl bromide, octyl bromide, lauryl chloride, benzyl chloride, or benzyl bromide, or an aryl halide. Examples of the nitrogen-containing salt represented by formula (D-5) include N-benzylpicolinium chloride, N-benzylpicolinium bromide, and N-laurylpicolinium chloride.

The nitrogen-containing salt represented by formula (D-6) can be derived from an amine. Examples of the anion (Y⁻) include halide ions such as chloride ion (Cl⁻), bromide ion (Br⁻), and iodide ion (I⁻), and organic anions having an anionic group such as —COO⁻, —SO₃⁻, or —O⁻. The nitrogen-containing salt represented by formula (D-6) can be produced by reaction of an amine with a weak acid such as a carboxylic acid or a phenol. The carboxylic acid may be formic acid or acetic acid. When formic acid is used, the anion (Y⁻) is HCOO⁻. When acetic acid is used, the anion (Y⁻) is CH₃COO⁻. When phenol is used, the anion (Y⁻) is C₆H₅O⁻.

In the quaternary phosphonium salt represented by formula (D-7), R³¹, R³², R³³, and R³⁴ are each preferably the same hydrocarbon group as R²¹ in formula (D-1). Preferably, three of R³¹ to R³⁴ are phenyl groups or substituted phenyl groups. Examples of the phenyl group or the substituted phenyl group include a phenyl group and a tolyl group. The remaining one is preferably an alkyl group having 1 or more and 18 or less carbon atoms. Examples of the anion (Y⁻) include halide ions such as chloride ion (Cl₋), bromide ion (Br⁻), and iodide ion (I⁻), and organic anions having an anionic group such as —COO⁻, —SO₃⁻, or —O⁻. The quaternary phosphonium salt represented by formula (D-7) is commercially available. Examples of the quaternary phosphonium salt represented by formula (D-7) include tetraalkylphosphonium halides such as tetra-n-butylphosphonium halide, tetra-n-propylphosphonium halide; trialkylbenzylphosphonium halides such as triethylbenzylphosphonium halide; triphenylmonoalkylphosphonium halides such as triphenylmethylphosphonium halide and triphenylethylphosphonium halide; triarylmonobenzylphosphonium halides such as triphenylbenzylphosphonium halide; tetraphenylphosphonium halide; tritolylmonoarylphosphonium halides such as tritolylmonophenylphosphonium halide; and tritolylmonoalkylphosphonium halides such as tritolylmonomethylphosphonium halide. In the examples of the quaternary phosphonium salt represented by formula (D-7), the halogen atom is chlorine or bromine. Particularly preferred examples include triphenylmonoalkylphosphonium halides such as triphenylmethylphosphonium halide and triphenylethylphosphonium halide; triarylmonobenzylphosphonium halides such as triphenylbenzylphosphonium halide; tritolylmonoarylphosphonium halides such as tritolylmonophenylphosphonium halide; and tritolylmonoalkylphosphonium halides such as tritolylmonomethylphosphonium halide.

Examples of the phosphine compound include primary phosphines such as methylphosphine, ethylphosphine, propylphosphine, isopropylphosphine, isobutylphosphine, and phenylphosphine; secondary phosphines such as dimethylphosphine, diethylphosphine, diisopropylphosphine, diisoamylphosphine, and diphenylphosphine; and tertiary phosphines such as trimethylphosphine, triethylphosphine, triphenylphosphine, methyldiphenylphosphine, and dimethylphenylphosphine.

In the tertiary sulfonium salt represented by formula (D-8) above, R³⁵, R³⁶, and R³⁷ are each preferably the same hydrocarbon group for R²¹ in formula (D-1). Preferably, two of R³⁵ to R³⁷ are each a phenyl group or a substituted phenyl group. Examples of the phenyl group or the substituted phenyl group include a phenyl group and a tolyl group. The remaining one is preferably an alkyl group having 1 or more and 18 or less carbon atoms or an aryl group. Examples of the anion (Y⁻) include halide ions such as chloride ion (Cl⁻), bromide ion (Br⁻), and iodide ion (I⁻), organic anions having an anionic group such as —COO⁻, —SO₃⁻, or —O⁻, maleate anion, and nitrate anion. The tertiary sulfonium salt represented by formula (D-8) is commercially available. Examples of the tertiary sulfonium salt represented by formula (D-8) include trialkylsulfonium halides such as tri-n-butylsulfonium halide and tri-n-propylsulfonium halide; dialkylbenzylsulfonium halides such as diethylbenzylsulfonium halide; diphenylmonoalkylsulfonium halides such as diphenylmethylsulfonium halide and diphenylethylsulfonium halide; and triarylsulfonium halides such as triphenylsulfonium halide. In the examples of the tertiary sulfonium salt represented by formula (D-8), the halogen atom is chlorine or bromine. Preferred examples of the tertiary sulphonium salt represented by formula (D-8) also include trialkylsulfonium carboxylates such as tri-n-butylsulfonium carboxylate and tri-n-propylsulfonium carboxylate; dialkylbenzylsulfonium carboxylates such as diethylbenzylsulfonium carboxylate; diphenylmonoalkylsulfonium carboxylates such as diphenylmethylsulfonium carboxylate and diphenylethylsulfonium carboxylate; and triphenylsulfonium carboxylate. Triphenylsulfonium halide, triphenylsulfonium carboxylate, or triphenylsulfonium nitrate is also preferably used as the tertiary sulfonium salt represented by formula (D-8).

A nitrogen-containing silane compound may also be used as the curing catalyst. Examples of the nitrogen-containing silane compound include imidazole ring-containing silane compounds such as N-(3-triethoxysilypropyl)-4,5-dihydroimidazole.

A silanol condensation catalyst as described below may be used as a curing catalyst other than the above for the composition for forming a hard coat. The silanol condensation catalyst acts to promote hydrolysis condensation reaction between hydrolyzable silyl groups of the silane-modified alicyclic compound molecules. The silanol condensation catalyst may be, but not limited to, an acid or a base, such as an organic acid, an inorganic acid, an organic base, or an inorganic base, or a metal chelate compound. Other examples include an organotin compound, a metal soap, and a platinum compound. Examples of a general silanol condensation catalyst other than an acid, a base, and a metal chelate compound include dibutyltin dilaurate, dioctyltin dilaurate, dibutyltin dioctoate, dibutyltin diacetate, zinc stearate, lead stearate, barium stearate, calcium stearate, sodium stearate, lead naphthenate, lead sulfate, zinc sulfate, and an organoplatinum compound.

Examples of the metal chelate compound include titanium chelate compounds such as titanium triethoxymono(acetylacetonate), titanium tri-n-propoxymono(acetylacetonate), titanium tri-isopropoxymono(acetylacetonate), titanium tri-n-butoxymono(acetylacetonate), titanium tri-sec-butoxymono(acetylacetonate), titanium tri-tert-butoxymono(acetylacetonate), titanium diethoxybis(acetylacetonate), titanium di-n-propoxybis(acetylacetonate), titanium di-isopropoxybis(acetylacetonate), titanium di-n-butoxybis(acetylacetonate), titanium di-sec-butoxybis(acetylacetonate), titanium di-tert-butoxybis(acetylacetonate), titanium monoethoxytris(acetylacetonate), titanium mono-n-propoxytris(acetylacetonate), titanium mono-isopropoxytris(acetylacetonate), titanium mono-n-butoxytris(acetylacetonate), titanium mono-sec-butoxytris(acetylacetonate), titanium mono-tert-butoxytris(acetylacetonate), titanium tetrakis(acetylacetonate), titanium triethoxymono(ethylacetoacetate), titanium tri-n-propoxymono(ethylacetoacetate), titanium tri-isopropoxymono(ethylacetoacetate), titanium tri-n-butoxymono(ethylacetoacetate), titanium tri-sec-butoxymono(ethylacetoacetate), titanium tri-tert-butoxymono(ethylacetoacetate), titanium diethoxybis(ethylacetoacetate), titanium di-n-propoxybis(ethylacetoacetate), titanium di-isopropoxybis(ethylacetoacetate), titanium di-n-butoxybis(ethylacetoacetate), titanium di-sec-butoxybis(ethylacetoacetate), titanium di-tert-butoxybis(ethylacetoacetate), titanium monoethoxytris(ethylacetoacetate), titanium mono-n-propoxytris(ethylacetoacetate), titanium mono-isopropoxytris(ethylacetoacetate), titanium mono-n-butoxytris(ethylacetoacetate), titanium mono-sec-butoxytris(ethylacetoacetate), titanium mono-tert-butoxytris(ethylacetoacetate), titanium tetrakis(ethylacetoacetate), titanium mono(acetylacetonate)tris(ethylacetoacetate), titanium bis(acetylacetonate)bis(ethylacetoacetate), and titanium tris(acetylacetonate)mono(ethylacetoacetate); zirconium chelate compounds such as zirconium triethoxymono(acetylacetonate), zirconium tri-n-propoxymono(acetylacetonate), zirconium tri-isopropoxymono(acetylacetonate), zirconium tri-n-butoxymono(acetylacetonate), zirconium tri-sec-butoxymono(acetylacetonate), zirconium tri-tert-butoxymono(acetylacetonate), zirconium diethoxybis(acetylacetonate), zirconium di-n-propoxybis(acetylacetonate), zirconium di-isopropoxybis(acetylacetonate), zirconium di-n-butoxybis(acetylacetonate), zirconium di-sec-butoxybis(acetylacetonate), zirconium di-tert-butoxybis(acetylacetonate), zirconium monoethoxytris(acetylacetonate), zirconium mono-n-propoxytris(acetylacetonate), zirconium mono-isopropoxytris(acetylacetonate), zirconium mono-n-butoxytris(acetylacetonate), zirconium mono-sec-butoxytris(acetylacetonate), zirconium mono-tert-butoxytris(acetylacetonate), zirconium tetrakis(acetylacetonate), zirconium triethoxymono(ethylacetoacetate), zirconium tri-n-propoxymono(ethylacetoacetate), zirconium tri-isopropoxymono(ethylacetoacetate), zirconium tri-n-butoxymono(ethylacetoacetate), zirconium tri-sec-butoxymono(ethylacetoacetate), zirconium tri-tert-butoxymono(ethylacetoacetate), zirconium diethoxybis(ethylacetoacetate), zirconium di-n-propoxybis(ethylacetoacetate), zirconium di-isopropoxybis(ethylacetoacetate), zirconium di-n-butoxybis(ethylacetoacetate), zirconium di-sec-butoxybis(ethylacetoacetate), zirconium di-tert-butoxybis(ethylacetoacetate), zirconium monoethoxytris(ethylacetoacetate), zirconium mono-n-propoxytris(ethylacetoacetate), zirconium mono-isopropoxytris(ethylacetoacetate), zirconium mono-n-butoxytris(ethylacetoacetate), zirconium mono-sec-butoxytris(ethylacetoacetate), zirconium mono-tert-butoxytris(ethylacetoacetate), zirconium tetrakis(ethylacetoacetate), zirconium mono(acetylacetonate)tris(ethylacetoacetate), zirconium bis(acetylacetonate)bis(ethylacetoacetate), and zirconium tris(acetylacetonate)mono(ethylacetoacetate); and aluminum chelate compounds such as aluminum tris(acetylacetonate) and aluminum tris(ethylacetoacetate).

Examples of the organic acid include acetic acid, propionic acid, butanoic acid, pentanoic acid, hexanoic acid, heptanoic acid, octanoic acid, nonanoic acid, decanoic acid, oxalic acid, maleic acid, methylmalonic acid, adipic acid, sebacic acid, gallic acid, melittic acid, arachidonic acid, 2-ethylhexanoic acid, oleic acid, stearic acid, linolic acid, linolenic acid, salicylic acid, benzoic acid, p-aminobenzoic acid, p-toluenesulfonic acid, benzenesulfonic acid, monochloroacetic acid, dichloroacetic acid, trichloroacetic acid, trifluoroacetic acid, formic acid, malonic acid, sulfonic acid, phthalic acid, fumaric acid, citric acid, and tartaric acid.

Examples of the inorganic acid include hydrochloric acid, nitric acid, sulfuric acid, hydrofluoric acid, and phosphoric acid.

Examples of the organic base include pyridine, pyrrole, piperazine, pyrrolidine, piperidine, picoline, trimethylamine, triethylamine, monoethanolamine, diethanolamine, dimethylmonoethanolamine, monomethyldiethanolamine, triethanolamine, diazabicyclooctane, diazabicyclononane, diazabicycloundecene, and tetramethylammonium hydroxide.

Examples of the inorganic base include ammonia, sodium hydroxide, potassium hydroxide, barium hydroxide, and calcium hydroxide.

Among these silanol catalysts, a metal chelate compound, an organic acid, and an inorganic acid are preferred. One or more of these silanol condensation catalysts may be used alone or simultaneously.

The silanol condensation catalyst may be used in any amount. The amount of the silanol condensation catalyst to be used is, for example, preferably 0.0001 parts by mass or more and 0.5 parts by mass or less, and more preferably 0.001 parts by mass or more and 0.1 parts by mass or less, based on 100 parts by mass of the total mass of the silane-modified alicyclic compound and other components capable of undergoing condensation. For the storage stability of the composition for forming a hard coat, the silanol condensation catalyst may be added to the composition immediately before the composition is used.

For the balance between the curing properties and the physical properties of the hard coat, the content of the curing agent(s) other than the silanol condensation catalyst described above may be 0.01 parts by mass or more and 10 parts by mass or less, preferably 0.01 parts by mass or more and 5 parts by mass or less, more preferably 0.05 parts by mass or more and 3 parts by mass or less, and even more preferably 0.1 parts by mass or more and 2 parts by mass or less, based on 100 parts by mass of the total mass of the silane-modified alicyclic compound and the other components capable of undergoing condensation.

When the composition for forming a hard coat contains a combination of the photoacid generator (A1) and the thermal acid generator (A2) as curing agents, the ratio of the mass of the photoacid generator (A1) to the total mass of the photoacid generator (A1) and the thermal acid generator (A2) is preferably 50% by mass or less, and more preferably 30% by mass or less, so that the hard coat can be more easily prevented from discoloration during the curing. The lower limit of the mass ratio is preferably, but not limited to, 10% by mass or more, more preferably 15% by mass or more, and even more preferably 20% by mass or more, for the chemical resistance of the hard coat and the process margin.

### <Other Additives>

The composition for forming a hard coat may contain any optional component other than the above components, such as an inorganic filler such as precipitated silica, wet silica, fumed silica, pyrogenic silica, titanium oxide, alumina, glass, quartz, aluminosilicate, iron oxide, zinc oxide, calcium carbonate, carbon black, silicon carbide, silicon nitride, or boron nitride; a thermosetting compound such as an epoxy compound or an oxetane compound; an organic resin fine powder such as silicone resin, epoxy resin, or fluororesin; an electrically conductive metal powder such as silver or copper; a curing aid; a stabilizer such as an antioxidant, an ultraviolet absorber, a light stabilizer, a heat stabilizer, or a heavy metal deactivator; a flame retardant such as a phosphorus-based flame retardant, a halogen-based flame retardant, or an inorganic flame retardant; a flame retardant aid; a nucleating agent; a coupling agent such as a silane coupling agent; a lubricant; a wax; a plasticizer; a mold release agent; an impact modifier; a color modifier; a clarifying agent; a rheology adjustor such as a fluidity modifier; a processability modifier; a coloring agent such as a dye or a pigment; an antistatic agent; a dispersing agent; a surface modifier such as a surfactant, an antifoaming agent, a leveling agent, or an anti-waking agent; a surface modifier such as a slip agent; a matting agent; a defoaming agent; an antifoaming agent; an air-release agent; an antimicrobial; an antiseptic; a viscosity modifier such as a thickener; a photosensitizer; a foaming agent; or any other well-known additives. One of these additives may be used alone, or two or more of these additives may be used in combination.

The inorganic filler may also be surface-treated with an organosilicon compound such as organohalosilane, organoalkoxysilane, or organosilazane.

Examples of the surfactant include nonionic surfactants including polyoxyethylene alkyl ethers such as polyoxyethylene lauryl ether, polyoxyethylene stearyl ether, polyoxyethylene cetyl ether, and polyoxyethylene oleyl ether; polyoxyethylene alkylallyl ethers such as polyoxyethylene octylphenol ether and polyoxyethylene nonylphenol ether; polyoxyethylene polyoxypropylene block copolymers; sorbitan fatty acid esters such as sorbitan monolaurate, sorbitan monopalmitate, sorbitan monostearate, sorbitan monooleate, sorbitan trioleate, and sorbitan tristearate; and polyoxyethylene sorbitan fatty acid esters such as polyoxyethylene sorbitan monolaurate, polyoxyethylene sorbitan monopalmitate, polyoxyethylene sorbitan monostearate, polyoxyethylene sorbitan trioleate, and polyoxyethylene sorbitan tristearate; fluorosurfactants such as Eftop EF301, EF303, and EF352 (trade names, manufactured by Tochem Products Co., Ltd.), Megafac F171, F173, R-08, R-30, R-30N, and R-40LM (trade names, manufactured by DIC Corporation), Fluorad FC430 and FC431 (manufactured by Sumitomo 3M Limited), and Asahi Guard AG710 and Surflon S-382, SC101, SC102, SC103, SC104, SC105, and SC106 (trade names, manufactured by AGC Inc.); and organosiloxane polymer KP341 (manufactured by Shin-Etsu Chemical Industry Co., Ltd.). These surfactants may be used alone or two or more of these surfactants may be used in combination. When the surfactant is used, the content of the surfactant may be 0.00001 parts by mass or more and 5 parts by mass or less, 0.0001 parts by mass or more and 1 part by mass or less, or 0.001 parts by mass or more and 1 part by mass or less, based on 100 parts by mass of the silane-modified alicyclic compound.

### <Solvent>

The composition for forming a hard coat preferably contains a solvent for such a purpose as adjustment of coating properties. Examples of such a solvent include nitrogen-containing polar solvents such as N-methyl-2-pyrrolidone, N,N-dimethylacetamide, N,N-diethylacetamide, N,N-dimethylformamide, N,N-diethylformamide, N-methylcaprolactam, and N,N,N′,N′-tetramethylurea; lactone polar solvents such as β-propiolactone, γ-butyrolactone, γ-valerolactone, δ-valerolactone, γ-caprolactone, and ε-caprolactone; dimethyl sulfoxide; acetonitrile; fatty acid esters such as ethyl lactate and butyl lactate; ethers such as diethylene glycol dimethyl ether, diethylene glycol diethyl ether, dioxane, tetrahydrofuran, methyl cellosolve acetate, and ethyl cellosolve acetate; and phenolic solvents such as cresols and xylene-based mixed solvents. One of these solvents may be used alone, or two or more of these solvents may be used in combination.

The solvent may be used in any amount. The solvent is preferably used in such an amount that the concentration of the components other than the solvent in the composition for forming a hard coat is 5% by mass or more and 50% by mass or less and more preferably 10% by mass or more and 30% by mass or less.

The solvent used for the synthesis of the silane-modified alicyclic compound may be used as it is as a solvent component of the composition for forming a hard coat. Alternatively, after the silane-modified alicyclic compound is isolated from the reaction solution by a well-known method, the silane-modified alicyclic compound may be mixed with any optional components and the solvent as needed.

### «Method for Producing an Article Having a Hard Coat»

Any method capable of forming a hard coat with desired properties on the surface of an article may be used for producing an article having a hard coat using the composition described above.

Any material may be hard-coated as long as the object of the present invention is not impaired. Examples of the material to be coated include plastics, metals, ceramics, semiconductor materials, glass, paper, and wood. Among these materials, plastics are preferred.

Examples of plastics include polyesters such as polyethylene terephthalate (PET) and polyethylene naphthalate (PEN); polyimides; polycarbonates; polyamides; polyacetals; polyphenylene oxides; polyphenylene sulfides; polyether sulfones; polyether ether ketones; cyclic polyolefins such as homopolymers of a norbornene monomer (e.g., addition polymers, ring-opened polymers) and copolymers of a norbornene monomer and an olefin monomer, such as a copolymer of norbornene and ethylene (e.g., cyclic olefin copolymers such as addition polymers and ring-opened polymers); vinyl polymers such as acrylic resins including polymethyl methacrylate (PMMA), polystyrene, polyvinyl chloride, and acrylonitrile-styrene-butadiene resin (ABS resin); vinylidene polymers such as polyvinylidene chloride; cellulose resins such as triacetyl cellulose (TAC); epoxy resins; phenolic resins; melamine resins; urea resins; maleimide resins; and silicone resins. The plastic article may be made of a single plastic material or a combination of two or more plastic materials.

A transparent hard-coated article may be produced. In this case, an article of a transparent plastic such as a polyester such as PET or PEN, a polycarbonate, a triacetyl cellulose, or an acrylic resin such as polymethyl methacrylate is preferably subjected to the coating.

When the article to be coated is made of a plastic, the plastic may contain, if necessary, one or more additive selected from the group consisting of an antioxidant, an ultraviolet absorber, a light stabilizer, a heat stabilizer, a crystal nucleating agent, a flame retardant, a flame retardant aid, a filler, a plasticizer, an impact modifier, a reinforcing agent, a dispersant, an antistatic agent, a foaming agent, and an antimicrobial agent.

When the article to be coated is a plastic sheet or pipe, the sheet or pipe may have a monolayer or multilayer structure.

The surface of the article to be coated may have partially or entirely undergone well-known surface treatment, such as roughening treatment, adhesion facilitating treatment, antistatic treatment, sandblasting treatment, corona discharge treatment, plasma treatment, chemical etching treatment, water matting treatment, flame treatment, acid treatment, alkali treatment, oxidation treatment, ultraviolet irradiation treatment, or silane coupling agent treatment.

A typical example of a method for producing an article having a hard coat using the composition for forming a hard coat includes:
applying the composition to a surface of a coating target article to form a coating film; and
drying the formed coating film. During the drying of the coating film, the silane-modified alicyclic compound undergoes crosslinking caused by hydrolysis condensation with water in the air, so that the coating film is cured to form a hard coat.

Any method appropriate for applying the composition for forming a hard coat may be selected by taking into account the shape of the hard-coating target article, and other conditions. When the hard-coating target article is a film or a sheet, the method for application may be a method using a contact transfer type coater such as a roll coater, a reverse coater, a bar coater, or a slit coater, or a method using a non-contact type coater such as a spinner (rotary coating machine) or a curtain flow coater. When the target article has a complicated shape, such a coating apparatus as a spray coater or a dip coater may be used. When a printing method such as an ink jet method is used, the coating film can be formed only in a specific area of the surface of the hard coating target article, so that the hard coat can be formed in a position-selective manner.

Using the composition described above, a hard coat with high hardness can be formed regardless of how thin the film is. Thus, the thickness of the coating film is preferably adjusted so that a hard coat with a thickness of 0.1 μm or more and less than 3 μm can be formed. The thickness of the hard coat is preferably 0.2 μm or more and 2.5 μm or less, and more preferably 0.3 μm or more and 2 μm or less.

The coating film formed in this way is then dried. While any method may be used for the drying, the coating film is preferably heated at 80° C. or more for the purpose of enhancing the crosslinking with the silane-modified alicyclic compound. A specific method includes, for example, performing reduced pressure drying at room temperature using a vacuum drying device (VCD) and then performing drying at a temperature of 80° C. or more, preferably 90° C. or more, for a time period within the range of 30 seconds or more and 10 minutes or less using a hot plate or the like. The drying temperature may have any upper limit that does not cause thermal deterioration or thermal decomposition of the silane-modified alicyclic compound. The upper limit of the drying temperature is, for example, preferably 200° C. or less, and more preferably 150° C. or less.

When the composition for forming a hard coat contains the photoacid generator (A1) and/or the thermal acid generator (A2), the coating film may be exposed to light and/or heated before or after the drying of the coating film. In this regard, some conditions may cause the thermal acid generator (A2) to generate an acid due to heating during the drying. Irradiation with actinic energy rays such as excimer laser beams may be performed for the exposure to light. The dose of the energy for the irradiation is preferably, for example, 10 mJ/cm² or more and 2,000 mJ/cm² or less, more preferably 30 mJ/cm² or more and 1,500 mJ/cm² or less, and even more preferably 50 mJ/cm² or more and 1,200 mJ/cm² or less, while it varies depending on the components of the composition for forming a hard coat. The temperature at which heating is performed on the coating film formed using the composition containing the thermal acid generator (A2) is, preferably, but not limited to, 80° C. or more and 280° C. or less, more preferably 90° C. or more and 260° C. or less, and even more preferably 100° C. or more and 250° C. or less. Typically, the heating time is preferably 1 minute or more and 60 minutes or less, more preferably 10 minutes or more and 50 minutes or less, and even more preferably 20 minutes or more and 40 minutes or less.

The silane-modified alicyclic compound contains an amic acid structure having an amide bond (—CO—NH—) on a carbon atom adjacent to the carbon atom to which the carboxy group is bonded. Therefore, heating the coating film or the hard coat at high temperature can cause the amic acid structure to undergo ring closure simultaneously with or after the condensation between the hydrolyzable silyl groups, so that the amic acid structure can be converted into a dicarboxylic imide structure. The coating film may be heated at a relatively low temperature. In this case, the resulting hard coat is also useful, which has been cured through hydrolysis condensation of the hydrolyzable silyl group of the silane-modified alicyclic compound. However, the hardness and various mechanical properties of the hard coat can be increased by forming the dicarboxylic imide structure as described above.

The heating temperature for forming the dicarboxylic imide structure is preferably 100° C. or more, more preferably 150° C. or more, and even more preferably 180° C. or more. The heating temperature may have any upper limit that does not cause the hard coat to undergo excessive thermal deterioration or thermal decomposition. The upper limit of the heating temperature is, for example, preferably 300° C. or less, more preferably 280° C. or less, and even more preferably 250° C. or less. Typically, the heating time is preferably 1 minute or more and 12 hours or less, more preferably 3 minutes or more and 6 hours or less, even more preferably 5 minutes or more and 3 hours or less, and further more preferably 10 minutes or more and 1 hour or less, depending on the heating temperature.

The temperature for heating the coating film or the hard coat is appropriately determined by taking into account the heat resistance of the material of the hard coating target article.

The degree of the imidization can be checked by fourier transform infrared spectroscopy (FT-IR) measurement on the coating film or the hard coat after the heating. Specifically, in the FT-IR measurement of the hard coat formed through the heating at 180° C. or more, the degree of the imidization may be calculated from the area A1 of the resulting peak at a wave number of 1591.0 cm⁻¹ to 1492.7 cm⁻¹ derived from —NH— in the carboxylic amide bond and the area A2 of the resulting peak at a wave number of 1801.2 cm⁻¹ to 1762.7 cm⁻¹ derived from the carbonyl group in the imide bond. The imidization is preferably performed such that the A2/A1 value is 0.8 or more. The A2/A1 value is more preferably 0.9 or more, even more preferably 1.0 or more, further more preferably 1.3 or more, and still more preferably 1.5 or more.

A hard-coated article is obtained by the method described above. The hard-coated article has the hard coat, which has been formed on the surface of the article using the composition described above. Preferred examples of the hard-coated article include a window, a mirror, and a lens each including an optically transparent material such as glass or optically transparent resin such as acrylic resin or polycarbonate. The hard-coated article also has a glossy hard-coated surface, which provides a good appearance and high durability against scratching. Therefore, the hard-coated article is also preferred as an interior part for various vehicles such as automobiles, railway vehicles, and ships.

### EXAMPLES

### Example 1

A 3 mL volume three-necked flask was charged with 23.2 g (104.8 mmol) of 3-aminopropyltriethoxysilane and 200 g of N,N,N′,N′-tetramethylurea (TMU). After the air in the flask was replaced by nitrogen gas, the materials in the flask were uniformly stirred so that 3-aminopropyltriethoxysilane was homogenized in TMU. Subsequently, 20 g (52.03 mmol) of an alicyclic tetracarboxylic dianhydride having the structure below was added into the flask, and then reacted at room temperature for 3 hours. After the reaction, TMU was distilled off from the reaction solution using a rotary evaporator, so that 80.61 g (92.3% yield) of a white solid of a silane-modified alicyclic compound C1 having the structure below was obtained. The result of ¹H-NMR measurement (deuterated DMSO, 400 MHz) of the resulting silane-modified alicyclic compound C1 was as follows.
δ (ppm)=11.5 (COOH, 2H), 7.70 (CH₂, 4H), 3.75 (CH₃, 12H), 2.95 (CH₂, 4H), 2.65 (CH, 2H), 2.30-2.05 (4H), 2.05-1.60 (14H), 1.45 (CH₂, 4 H), 1.15 (CH₃, 18H), 1.05 (CH, 2H), 0.55 (CH₂, 4H).

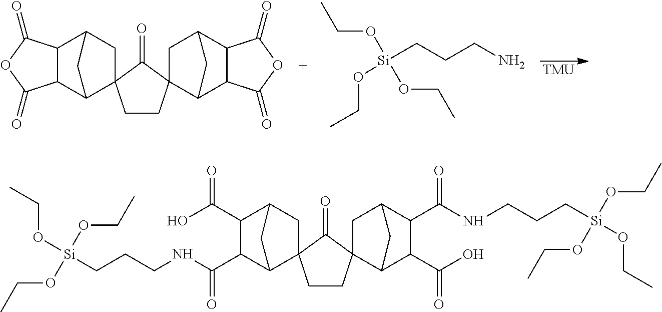

### Example 2

The silane-modified alicyclic compound C1 obtained in Example 1 was dissolved at a concentration of 20% by mass in TMU again to form a composition for forming a hard coat. The resulting composition for forming a hard coat had a viscosity of 3 to 6 cP as measured at 25° C. with an E type viscometer. The composition for forming a hard coat had a water content of less than 1% by mass as measured by Karl Fischer method. The resulting composition for forming a hard coat was subjected to pencil hardness measurement, FT-IR measurement, mechanical property evaluation, transparency evaluation, weather resistance test, high-temperature, high-humidity test, and light resistance test according to the procedures below.

### <Pencil Hardness Evaluation>

The composition for forming a hard coat was applied onto a silicon wafer and a polyimide film to form a coating film. The coating film was then heated at 80° C. for 2 minutes. The coating film to be tested on the silicon wafer was then heated at 160° C., 200° C., or 230° C. for 20 minutes to form a 1 μm thick hard coat. The coating film to be tested on the polyimide film was then heated at 200° C. or 230° C. for 20 minutes to form a 1 μm thick hard coat. The pencil hardness of the hard coat formed on the silicon wafer or the polyimide film was measured according to ISO 15184 and JIS K 5600-5-4 under the conditions of an angle of 45° and a load of 750 g using a pencil hardness tester. The results of the measurement were as follows.
On silicon wafer
Heating temperature 160° C.: pencil hardness H
Heating temperature 200° C.: pencil hardness 6H
Heating temperature 230° C.: pencil hardness 9H
On polyimide film
Heating temperature 200° C.: pencil hardness H
Heating temperature 230° C.: pencil hardness 4H

The results of the pencil hardness evaluation show that, when the composition containing the silane-modified alicyclic compound satisfying the specific requirements descried above was used to form a hard coat, the resulting hard coat had high pencil hardness both on the hard silicon wafer and on the soft polyimide film.

### <FT-IR Measurement>

The hard coat formed through heating at 160° C. for 20 minutes, heating at 200° C. for 20 minutes, or heating at 230° C. for 20 minutes was subjected to FT-IR measurement. The results of the FT-IR measurement were used to calculate the area A1 of the peak at a wave number of 1591.0 cm⁻¹ to 1492.7 cm⁻¹ derived from —NH— in the carboxylic amide bond and the area A2 of the peak at a wave number of 1801.2 cm⁻¹ to 1762.7 cm⁻¹ derived from the carbonyl group in the imide bond. The resulting A1 and A2 values were used to calculate the A2/A1 value. A higher A2/A1 value indicates a higher degree of conversion to the dicarboxylic imide structure from the amic acid structure derived from the silane-modified alicyclic compound. The A2/A1 value is shown below for each curing temperature.
A2/A1
160° C.: 0.396
200° C.: 1.019
250° C.: 1.559

The results of the pencil hardness evaluation and the FT-IR measurement show that, when the A2/A1 value was 0.8 or more, the imidization was allowed to proceed sufficiently to increase the pencil hardness of the hard coat significantly.

### <Mechanical Property Evaluation>

The same method as in the pencil hardness evaluation was used to form a hard coat on a polyimide film, in which the hard coat was cured through heating at 230° C. for 20 minutes. The resulting hard-coated polyimide film and the polyimide film with no hard coat were subjected to measurement of tensile stress (MPa), tensile elongation (%), and bending strength (GPa) according to ISO 527. These measurement results are shown in Table 1 below.

TABLE 1

| | Polyimide | Hard-coated |
|---|---|---|
| | film | polyimide film |
| Tensile stress (MPa) | 164.04 | 183.63 |
| Tensile elongation (%) | 12.52 | 14.56 |
| Bending strength (GPa) | 4.82 | 4.85 |

Table 1 shows that using the composition containing the silane-modified alicyclic compound obtained in Example 1 to form a hard coat on a polyimide film significantly improved the tensile stress and the tensile elongation without causing degradation of the mechanical properties of the polyimide film itself with no hard coat.

### <Transparency Evaluation>

A hard coat was formed using the same method as in the pencil hardness evaluation, except that a 3 μm thick hard coat was formed on a glass substrate. The laminate of the glass substrate and the hard coat had a light transmittance of 100% as measured at a wavelength of 400 nm and an average light transmittance of 100% in the wavelength range of 380 to 780 nm. This means that the hard coat formed using the composition containing the silane-modified alicyclic compound obtained in Example 1 had excellent transparency.

### <Weather Resistance Test>

A hard coat was formed on a glass substrate using the same method as in the transparency evaluation, except that the thickness of the hard coat was changed to 1 μm. The resulting hard-coated glass substrate was subjected to a weather resistance test under the condition of 150° C. for 1,000 hours. As a result, almost no change was found in the thickness of the hard coat or the light transmittance of the laminate of the glass substrate and the hard coat before and after the weather resistance test. This means that the hard coat formed using the composition containing the silane-modified alicyclic compound obtained in Example 1 had excellent weather resistance.

### <High-Temperature, High-Humidity Test>

A hard coat was formed on a glass substrate using the same method as in the transparency evaluation, except that the thickness of the hard coat was changed to 1 μm. The resulting hard-coated glass substrate was subjected to a high-temperature, high-humidity test under the conditions of 85° C. and a relative humidity of 85% for 100 hours. As a result, almost no change was found in the thickness of the hard coat or the light transmittance of the laminate of the glass substrate and the hard coat before and after the high-temperature, high-humidity test. This means that the hard coat formed using the composition containing the silane-modified alicyclic compound obtained in Example 1 had excellent resistance to high-temperature and high-humidity.

### <Light Resistance Test>

A hard coat was formed on a glass substrate using the same method as in the transparency evaluation, except that the thickness of the hard coat was changed to 1 μm.
The resulting hard-coated glass substrate was subjected to a light resistance test under the conditions of irradiation with a xenon light source for 250 hours. As a result, almost no change was found in the thickness of the hard coat or the light transmittance of the laminate of the glass substrate and the hard coat before and after the light resistance test. This means that the hard coat formed using the composition containing the silane-modified alicyclic compound obtained in Example 1 had excellent light resistance.

### Example 3

A 3 mL volume three-necked flask was charged with 26.9 g (121.4 mmol) of 3-aminopropyltriethoxysilane and 160 g of TMU. After the air in the flask was replaced by nitrogen gas, the materials in the flask were uniformly stirred so that 3-aminopropyltriethoxysilane was homogenized in TMU. Subsequently, 13.1 g (58.5 mmol) of 1,2,4,5-cyclohexanetetracarboxylic dianhydride was added into the flask, and then reacted at room temperature for 3 hours, so that a solution containing 200 g (a concentration of 20% by mass) of a silane-modified alicyclic compound C2 having the structure below was obtained. The result of ¹H-NMR measurement (deuterated DMSO, 400 MHz) of the resulting silane-modified alicyclic compound C2 was as follows.
δ (ppm)=11.5 (COOH, 2H), 7.70 (NH, 2H), 3.70 (CH₂, 12H), 2.70 (CH₂, 4H), 2.6-2.4 (CH, 2H), 2.00 (CH, 3H), 1.40 (CH₂, 4H), 1.2-1.0 (CH₃, 18H), 0.55 (CH_{2, 4}H).

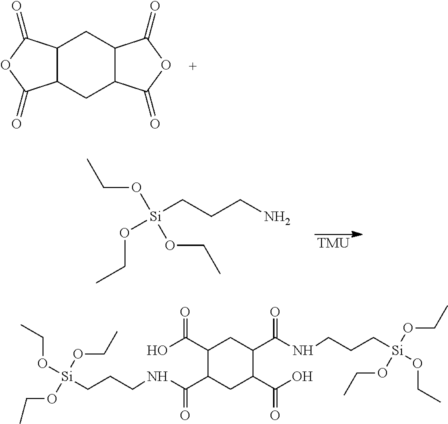

### Example 4

The solution of the silane-modified alicyclic compound C2 obtained in Example 3 was used as a composition for forming a hard coat without any modification. The composition of Example 4 was used to form a hard coat, which was evaluated for pencil hardness according to the method below.

### <Pencil Hardness Evaluation>

The composition for forming a hard coat was applied onto a silicon wafer and a polyimide film to form a coating film. The coating film was then heated at 80° C. for 2 minutes. The coating film to be tested on the silicon wafer was then heated at 160° C., 200° C., or 230° C. for 20 minutes to form a 1 μm thick hard coat. The coating film to be tested on the polyimide film was then heated at 230° C. for 20 minutes to form a 1 μm thick hard coat. The pencil hardness of the hard coat formed on the silicon wafer or the polyimide film was measured according to ISO 15184 and JIS K 5600-5-4 under the conditions of an angle of 45° and a load of 750 g using a pencil hardness tester. The results of the measurement were as follows.
On silicon wafer
Heating temperature 160° C.: pencil hardness H
Heating temperature 200° C.: pencil hardness 5H
Heating temperature 230° C.: pencil hardness 7H
On polyimide film
Heating temperature 230° C.: pencil hardness 2H

### Example 5 and Example 6

In Example 5, a photoacid generator 1 was added to the composition of Example 2 to form a composition for forming a hard coat. In Example 6, a thermal acid generator 1 was added to the composition of Example 2 to form a composition for forming a hard coat. The photoacid generator 1 was a sulfonium salt composed of diphenyl(3-methyl(4-phenylthio)phenyl)sulfonium cation and tetrakis(pentafluorophenyl)boron anion. The thermal acid generator 1 was a sulfonium salt composed of (4-hydroxyphenyl)methyl(benzyl)sulfonium cation and tetrakis(pentafluorophenyl)gallium cation. In both of Examples 5 and 6, the solid content ratio of the silane-modified alicyclic compound C1 to the acid generator was 99:1 by mass ratio. The resulting compositions of Examples 5 and 6 for forming a hard coat each had a viscosity of 3 to 6 cP as measured at 25° C. with an E type viscometer. The compositions of Examples 5 and 6 for forming a hard coat each had a water content of less than 1% by mass as measured by Karl Fischer method. The resulting compositions were each subjected to pencil hardness measurement according to the procedure below.

### <Pencil Hardness Evaluation>

Each composition for forming a hard coat was applied onto a silicon wafer and a polyimide film to form a coating film. The coating film was then heated at 80° C. for 2 minutes. The coating films to be tested on the silicon wafer and the polyimide film were then each heated at 230° C. for 20 minutes to form a 1 μm thick hard coat. The pencil hardness of the hard coat formed on the silicon wafer or the polyimide film was measured according to ISO 15184 and JIS K 5600-5-4 under the conditions of an angle of 45° and a load of 750 g using a pencil hardness tester. For both compositions of Examples 5 and 6, the results of the measurement were as follows.
On silicon wafer
Heating temperature 230° C.: pencil hardness 9H
On polyimide film
Heating temperature 230° C.: pencil hardness 5H

1. A composition for forming a hard coat, the composition comprising a silane-modified alicyclic compound having a hydrolyzable silyl group, wherein the silane-modified alicyclic compound is a mixture of products of reaction of 1 part by mole of an alicyclic tetracarboxylic dianhydride with more than 0.5 parts by mole of an aminosilane compound represented by formula (a-1):
R^{a1}ₜR^{a2}₍₃₋ₜ₎Si—R^{a3}—NH₂ (a-1)
wherein R^{a1} is a group capable of undergoing hydrolysis to produce a silanol group, R^{a2} is an optionally substituted hydrocarbon group, R^{a3} is an aliphatic chain group, and t is 2 or 3.

2. The composition according to claim 1, wherein the alicyclic tetracarboxylic dianhydride is a compound represented by formula (a-2-1): 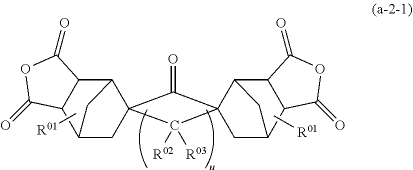
wherein R⁰¹, R⁰², and R⁰³ each independently represents one selected from the group consisting of a hydrogen atom, an alkyl group having 1 or more and 10 or less carbon atoms, and a fluorine atom, and u represents an integer of 0 or more and 12 or less.

3. The composition according to claim 1, wherein the silane-modified alicyclic compound is a mixture of products of reaction of 1 part by mole of the alicyclic tetracarboxylic dianhydride with 0.7 parts by mole or more and 2.5 parts by mole or less of the aminosilane compound.

4. The composition according to claim 1, wherein t is 3, R^{a1} is an alkoxy group having 1 or more and 4 or less carbon atoms, and R^{a3} is an alkylene group having 1 or more and 10 or less carbon atoms.

5. A composition for forming a hard coat, the composition comprising a compound represented by formula (a-I) only as a silane-modified alicyclic compound or comprising, as a silane-modified alicyclic compound, a combination of a compound represented by formula (a-I) and a compound represented by formula (a-II-1) and/or a compound represented by formula (a-II-2): 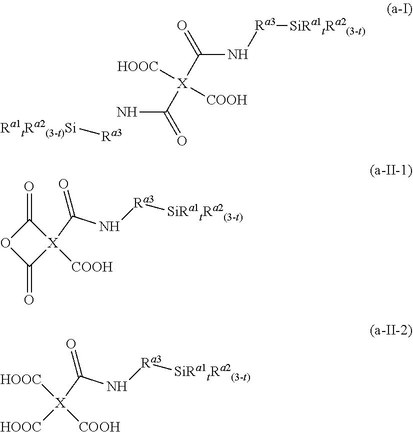
wherein R^{a1} is a group capable of undergoing hydrolysis to produce a silanol group, R^{a2} is an optionally substituted hydrocarbon group, R^{a3} is an aliphatic chain group, t is 2 or 3, and X is a tetravalent aliphatic group containing an alicyclic skeleton.

6. The composition according to claim 5, wherein the compound represented by formula (a-I) is a compound represented by formula (a-I-a), the compound represented by formula (a-II-1) is a compound represented by formula (a-II-a), and the compound represented by formula (a-II-2) is a compound represented by formula (a-II-b): 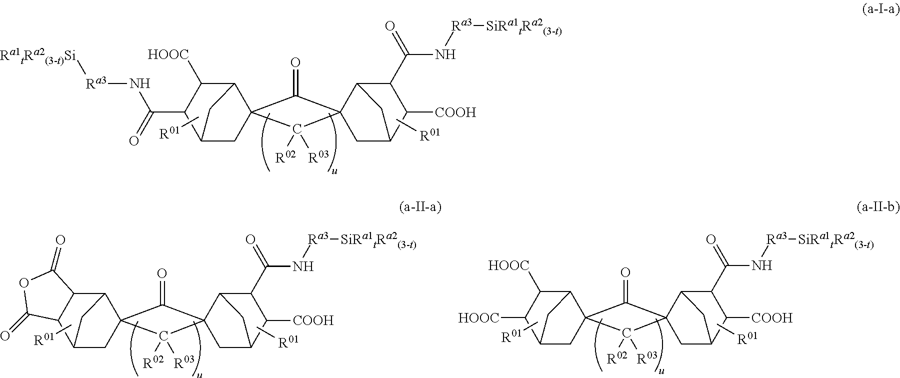
wherein R^{a1} is a group capable of undergoing hydrolysis to produce a silanol group, R^{a2} is an optionally substituted hydrocarbon group, R^{a3} is an aliphatic chain group, t is 2 or 3, R⁰¹, R⁰², and R⁰³ each independently represent one selected from the group consisting of a hydrogen atom, an alkyl group having 1 or more and 10 or less carbon atoms, and a fluorine atom, and u represents an integer of 0 or more and 12 or less.

7. The composition according to claim 5, wherein t is 3, R^{a1} is an alkoxy group having 1 or more and 4 or less carbon atoms, and R^{a2} is an alkylene group having 1 or more and 10 or less carbon atoms.

8. A method for producing an article having a hard coat, the method comprising:
applying the composition according to claim 5 to a surface of a coating target to form a coating film; and
drying the coating film.

9. The method according to claim 8, wherein the hard coat is formed through heating at 180° C. or more, and the hard coat has an A2/A1 value of 0.8 or more calculated from A1 and A2, wherein A1 is an area of a peak at a wave number of 1591.0 cm⁻¹ to 1492.7 cm⁻¹ derived from —NH— in a carboxylic amide bond, which is obtained when the hard coat is measured by FT-IR, and A2 is an area of a peak at a wave number of 1801.2 cm⁻¹ to 1762.7 cm⁻¹ derived from a carbonyl group in an imide bond, which is obtained when the hard coat is measured by FT-IR.

10. The method according to claim 8, wherein the hard coat has a thickness of 0.1 μm or more and less than 3 μm.

11. A hard coat comprising a cured product of the composition according to claim 5.

12. The hard coat according to claim 11, which has an A2/A1 value of 0.8 or more calculated from A1 and A2, wherein A1 is an area of a peak at a wave number of 1591.0 cm⁻¹ to 1492.7 cm⁻¹ derived from —NH— in a carboxylic amide bond, which is obtained when the hard coat is measured by FT-IR, and A2 is an area of a peak at a wave number of 1801.2 cm⁻¹ to 1762.7 cm⁻¹ derived from a carbonyl group in an imide bond, which is obtained when the hard coat is measured by FT-IR.

13. The hard coat according to claim 11, which has a thickness of 0.1 μm or more and less than 3 μm.

14. A hard-coated article comprising an article and the hard coat according to claim 11 provided on a surface of the article.

15. A silane-modified alicyclic compound represented by formula (a-I), (a-II-1) or (a-II-2): 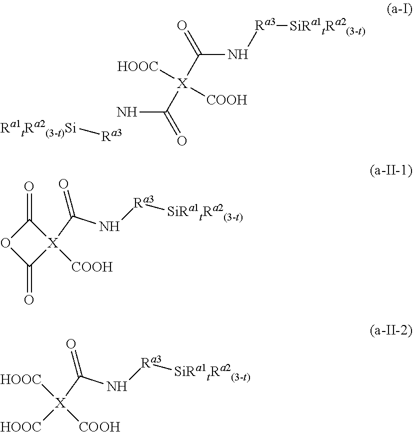
wherein R^{a1} is a group capable of undergoing hydrolysis to produce a silanol group, R^{a2} is an optionally substituted hydrocarbon group, R^{a3} is an aliphatic chain group, t is 2 or 3, and X is a tetravalent aliphatic group containing an alicyclic skeleton.

16. The silane-modified alicyclic compound according to claim 15, wherein the compound represented by formula (a-I) is a compound represented by formula (a-I-a), the compound represented by formula (a-II-1) is a compound represented by formula (a-II-a), and the compound represented by formula (a-II-2) is a compound represented by formula (a-II-b): 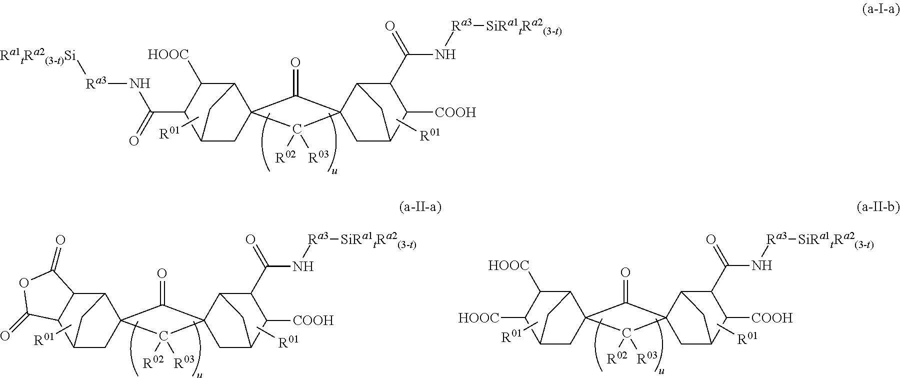
wherein R^{a1} is a group capable of undergoing hydrolysis to produce a silanol group, R^{a2} is an optionally substituted hydrocarbon group, R^{a3} is an aliphatic chain group, t is 2 or 3, R⁰¹, R⁰², and R⁰³ each independently represent one selected from the group consisting of a hydrogen atom, an alkyl group having 1 or more and 10 or less carbon atoms, and a fluorine atom, and u represents an integer of 0 or more and 12 or less.

17. The silane-modified alicyclic compound according to claim 15, wherein t is 3, R^{a1} is an alkoxy group having 1 or more and 4 or less carbon atoms, and R^{a2} is an alkylene group having 1 or more and 10 or less carbon atoms.
